(19) United States
(12) Patent Application Publication
(10) Pub. No.: US 2026/0195675 A1
(43) Pub. Date: Jul. 9, 2026

(54) SYSTEM AND METHOD FOR AUTOMATED WORK SHIFT MANAGEMENT

(71) Applicant: James Royce, New York, NY (US)

(72) Inventor: James Royce, New York, NY (US)

(21) Appl. No.: 19/443,201

(22) Filed: Jan. 8, 2026

Related U.S. Application Data
(60) Provisional application No. 63/743,255, filed on Jan. 9, 2025.

(51) Int. Cl. G06Q 10/0631

(52) U.S. Cl. CPC G06Q 10/06312

(57) ABSTRACT

The present invention discloses a system and method for automated work shift management. The system comprises a user device, a database, a computing device in communication with the database and the user device via a network. The user device is associated with a user. The database configured to store an operational requirement data, an employee preference data received and a performance history of an employee. The computing device is configured to receive the operational requirement and employee preference data via the user device. Further, the computing device is configured to assign weekly schedules and corresponding physical assets to employees manually based on preferences and equipment care scores, and automatically based on performance history. The computing device is configured to enable to modify, finalize and publish the weekly schedules. The computing device is configured to evaluate employee performance and update the performance score to generate a weekly summary and performance reports.

### CROSS REFERENCE TO RELATED APPLICATION

This application claims the priority benefit of the U.S. Provisional Patent Application No. 63/743,255 titled “SYSTEM AND METHOD FOR AUTOMATED WORK SHIFT SCHEDULING” filed on Jan. 9, 2025, the contents of which are hereby incorporated by reference in their entirety.

### TECHNICAL FIELD

The present invention generally relates to work shift management. More particularly, the invention is related to a system and method for automated work shift management. The method is particularly suited to the needs of last-mile delivery, where customer demand changes rapidly, making it necessary to adapt scheduling based on partial information. The dual-phase approach enables an initial assignment and subsequent adjustments to solve a specific problem encountered in the industry. Further, the method adjusts schedules dynamically, ensuring optimal resource allocation and worker readiness even when faced with incomplete initial data. The system and method are executed in a SaaS-based multi-tenant platform that provides scalability, customizability, and extensibility.

### BACKGROUND

In many industries, shift workers follow work shift scheduling to ensure tasks are completed efficiently and operations run smoothly. Work shift of each week is divided into several shifts and each shift assigned to different shift workers. The work shift includes specific hours, assigned tasks and other measurable work parameters that helps the shift workers to work efficiently.

Work shift scheduling is usually done manually by management, which often takes several hours to create each schedule and involves one or more people. However, manual scheduling might frequently lead to human errors due to the use of incomplete or incorrect employee information. Further, shift workers might feel dissatisfaction or unfair in the process if shift workers believe that schedules are not based on clear criteria, for example, seniority, performance, or personal availability that contribute to a sense of inequality among employees. Further, a few patent references related to work shift scheduling are discussed as follows.

US20180158548 of Soh Peter Taheri et al., entitled “Data processing systems for scheduling work shifts, such as physician work shifts” discloses a computer-implemented data processing method that is used for electronically scheduling workers to unassigned shifts based on various criteria associated with the unassigned shifts. The system first receives a set of scheduling data from a first business computer for unassigned work shifts that are available during a scheduling period. Further, the first business computer identifies one or more users that meet the particular criteria associated with each one of the unassigned work shifts. The system further provides a notification to a first user about a set of unassigned work shifts available for assignment. The system is configured to display the shifts to the first user and receives a request from the first user to assign the unassigned work shifts. Further, in response to the request of the user, the system facilitates the assignment of unassigned work shifts to the first user.

US20200012991 of Leonard John Podgurny et al., entitled “Method and system for assigning jobs to prevent employee qualifications from lapsing” discloses a method for assigning jobs to employees. The method involves identifying a job requiring a specific job qualification, which includes associated requirements that must be fulfilled within a designated time frame to maintain the qualification. The method further involves selecting and assigning the job to an employee from a pool of qualified employees. The selection is based, at least in part, on the probability of each employee losing their qualification relative to others in the pool, thereby prioritizing those at higher risk of qualification expiration.

However, the current system for scheduling work shift is based on the task and qualification required to complete the work without considering preferences of the employees. Further, the current system assigns work shifts to the employee without considering employees schedules, which might lead to frustration and dissatisfaction to work. Further, the employee's dissatisfaction could lead to higher rates of absenteeism and employee turnover that affects the operations and workforce management. Additionally, multi-organization shift scheduling for last-mile delivery presents significant challenges, including dynamic customer demands with incomplete information that require schedules to adapt rapidly, and coordinating shifts across different companies. Further, traditional manual scheduling processes are labor-intensive, error-prone, and incapable of responding efficiently to real-time changes. Additionally, failure to consider employee preferences and qualifications often leads to dissatisfaction, absenteeism, and high turnover. A critical challenge is ensuring data security and isolation while managing sensitive information across multiple entities.

Therefore, there is a need of a system for automated work shift scheduling that considers employee preferences, availability, and personal schedules. Further, the system needs to align work shifts with employee preferences that helps to decrease absenteeism and turnover rates, and enhance overall operational efficiency and workforce management. Further, the system needs to coordinate shifts across different companies, provides scalability, manage varying schedules, and ensure consistent communication between multiple teams. The system needs to ensure data isolation to protect proprietary information while supporting collaborative operations.

### SUMMARY

The present invention discloses a system and method for automated work shift management. The system is configured to manage work shift scheduling to ensure tasks are completed efficiently and smoothly. The system comprises at least one computing device and at least one database in communication with the computing device via a network. The system further comprises a user device and the database are in communication with the computing device via the network. The user device is associated with at least one user. The users comprise a scheduler, an employee, one or more super administrators, and one or more Distribution Service Providers (DSP) administrators.

The database is configured to store one or more operational requirement data received from the scheduler; an employee preference data received from the employee, and a performance history of the employee. The operational requirement data includes a template comprising shift types, shift timings, distribution times, required qualifications for each shift, locations, capacity limits per location, scheduling settings, feedback metrics, aggregate shift coverage by type and day, individual employee schedules, manual assignments, weekly targets, and required employee availability. The employee preference data includes preferred days of the week, preferred shift types, preferred work locations, preferred working hours, availability data including leave and time-off requests, shift qualification levels, overtime consent, qualification updates, and any last-minute unavailability of the employees. The performance history of the employee comprises previous shift performance score, adherence to scheduled timings, overtime records, match confidence percentage, behavioral status, and equipment care scores derived from historical behavioral data of each employee with corresponding physical asset.

The system is executed in a Software as a Service (SaaS). The Software as a Service (SaaS)-based multi-tenant platform is configured to provide isolated data environments and customizable settings for each of a plurality of companies. The SaaS platform comprises a role-based access control (RBAC). The RBAC is configured to enable the scheduler to create at least one template for operational requirement, the employee to provide the employee preferences, the super admins to manage subscriptions and handle employee roles and permissions, and the distribution service provider (DSP) admins to manage operations and employee engagement. The computing device comprises at least one memory configured to store a set of program modules and at least one processor configured to execute one or more program modules. The program modules comprise an input module, a roster module, a roster management module, an analytic module, a summary generating module, a forecasting module, a verification module, and a tracking module.

The input module is configured to receive the operational requirement data and the employee preference data via the user device. The roster module is configured to assign at least one weekly schedule and corresponding physical assets for each employee manually based on the employee preference data and the equipment care score aligned with the operational requirement data, and automatically based on the performance history. The weekly schedules include a daily shift and one or more upcoming shifts with corresponding tasks.

The roster management module is configured to organize the daily shift. The roster management module is configured to enable the scheduler to modify and finalize the daily shift based on last-minute updates received from the employee. The roster management module is further configured to publish the finalized daily shift schedule and task to the employee. The roster management module is further configured to balance one or more parameters for producing optimized and equitable scheduling outcomes. The parameters include minimizing unfilled shifts and over-assigned hours, maximizing driver satisfaction with respect to both preferred days and shifts, and giving priority to preferred locations during the rostering process. Further, the roster management module is configured to encourage time consistency with the previous week's shifts, reduce overtime penalties, and reward familiarity by providing bonuses for frequently assigned locations.

The analytic module is configured to analyze the performance of the employee to generate a performance score and assess the condition of physical assets to update the proprietary equipment care score. The analytic module is further configured to manage workforce coaching and rewards, and evaluates key performance indicators (KPIs), including delivery accuracy, adherence to safety protocols, and teamwork. The coaching workflow comprises a note-based history and provides escalation triggers to initiate formal offboarding or remediation processes for underperforming employee. The analytic module comprises one or more scenario setups configured to evaluate the effect of incorporating changes into upcoming shifts and tasks. The changes comprise the changes made to the operational requirement data, shift type, employee, and location. Further, the analytic module is configured to determine whether the changes produce improved scheduling results.

The analytic module comprises a complete cover. The complete cover comprises one or more graphs configured to provide real-time insight into shift coverage efficiency and staffing optimization, including daily shift coverage, overstaffed and understaffed shifts, locations, employees available for overtime (OT), imbalanced qualification distributions, and missed opportunities resulting from restrictive day or shift preferences. The understaffed shifts employees are categorized according to overtime preferences, including preferred overtime, reasonable overtime, tolerable overtime, and intolerable overtime.

The analytic module is configured to evaluate leave, time-off records, and availability data of the employee to ensure no shifts are assigned on zero-preference or unavailable days. The analytic module is further configured to verify driver qualification to confirm eligibility for assigned shifts based on the required certification or license type. The analytic module is further configured to ensure each employee is assigned to only one shift per day in compliance with labor and fatigue standards. The analytic module is further configured to ensure each employee is assigned within predefined capacity parameters corresponding to the specific shift, location, and time.

Further, the analytic module is configured to detect manually assigned shifts and ensure manual assignments remain unaltered during automated optimization processes. The analytic module is further configured to calculate total assigned working hours to enforce maximum limits defined by contractual and regulatory maximum working hour limits. The analytic module is further configured to verify overtime consent enforcement to avoid assigning shifts beyond standard working hours for employees who have not agreed to work overtime. The analytic module is further configured to ensure combined overtime hours across all the employee do not exceed the global company-defined limit.

The analytic module is further configured to ensure the employees do not exceed a predetermined number of consecutive working days and hours to prevent burnout and maintain compliance. The analytic module is further configured to perform two-week continuity analysis to detect excessive continuous work cycles. The analytic module is further configured to validate the integrity of shift-location-time mappings, excluding invalid configurations. Further, the analytic module is configured to analyze and balance overall workload distribution to ensure fair allocation of total hours and shifts among all available employees. The analytic module is further configured to enable automated computation of bonuses and penalty deductions based on predefined performance thresholds via a payroll system. The summary generating module is configured to generate one or more weekly summaries and performance reports based on the performance score and proprietary equipment care score.

The forecasting module is configured to automatically forecast the upcoming shifts and tasks based on weekly summaries and performance reports. The forecasting module is configured to evaluate the alignment between workforce availability and delivery objectives based on a visual and predictive staffing engine. The forecasting module is further configured to identify overstaffing, understaffing, and skill mismatches by comparing actual staffing levels with target shift coverage. The forecasting module is further configured to optimize scheduling arrangements for maximum shift coverage and suggestions to reallocate shifts and relax scheduling constraints. Further, the forecasting module is configured to generate staffing arrangements based on predefined variables, including overtime thresholds and preference override options.

The verification module is configured to verify the attendance of the employee at one or more depot entry points based on one or more attributes. The attributes include, but not limited to, uniform compliance, identity recognition, and behavioral analysis via a camera. The verification module is configured to record the identity recognition to match confidence level of the employee and flag a failed verification attempt. The verification module is further configured to enable a supervisor to manually verify the employee following the failed verification. The verification module is further configured to record the action of the supervisor along with a timestamp. The verification module is further configured to enable the supervisors to validate asset condition at check-in and return points. Further, the verification module is configured to generate one or more incident tickets for lost or damaged assets, missed handovers, or incomplete routes. The verification module is configured to assign and transmit equipment care scores to central operational dashboards.

The notification module is configured to notify the employee regarding changes made to finalized schedules and tasks. The notification module is further configured to generate one or more alerts to the scheduler regarding employee last-minute updates and compliance breaches. Further, the notification module is configured to maintain a complete history of all manual overrides performed on schedules. The tracking module is configured to track the status of physical assets assigned to the employees. The status includes active, in repair, or suspended. The tracking module is further configured to maintain a log of equipment issuance and return activities. The tracking module is further configured to automatically detect and flag any asset with historical damage for corresponding penalty deductions.

The computing device further comprises one or more artificial intelligence (AI) assistants. At least one AI assistant is configured to provide answers for one or more workforce-related queries. The queries are related to employee attendance, shift coverage, performance metrics, and summaries, and the frequently used queries are stored as reusable dashboard widgets for rapid access. The answers are provided in one or more formats, including spreadsheets, charts, graphs, and trendlines. At least one AI assistant is implemented as a chatbot comprising a text messaging feature and a voice call function. The chatbot is configured to assist the user with on-screen issues by providing interactive guidance, troubleshooting steps, and contextual recommendations based on the current user interface.

In one embodiment, a method for automated work shift management is disclosed. The method is incorporated in the system comprising at least one computing device and at least one database in communication with the computing device via the network. The system further comprises the user device and the database are in communication with the computing device via the network. The user device is associated with at least one user. The users comprise a scheduler, an employee, one or more super administrators, and one or more Distribution Service Providers (DSP) administrators.

The database is configured to store one or more operational requirement data received from the scheduler, an employee preference data received from the employee, and a performance history of the employee. The operational requirement data includes a template comprising shift types, shift timings, distribution times, required qualifications for each shift, locations, capacity limits per location, scheduling settings, feedback metrics, aggregate shift coverage by type and day, individual employee schedules, manual assignments, weekly targets, and required employee availability. The employee preference data includes preferred days of the week, preferred shift types, preferred work locations, preferred working hours, availability data including leave and time-off requests, shift qualification levels, overtime consent, qualification updates, and any last-minute unavailability of the employees. The performance history of the employee comprises previous shift performance score, adherence to scheduled timings, overtime records, match confidence percentage, behavioral status, and equipment care scores derived from historical behavioral data of each employee with corresponding physical asset.

The computing device comprises at least one memory configured to store the set of program modules and at least one processor configured to execute one or more program modules. The program modules comprise the input module, the roster module, the roster management module, the analytic module, the summary generating module, the forecasting module, the verification module, and the tracking module.

At one step, the input module, at the computing device, is configured to receive the operational requirement data and the employee preference data via the user device. At another step, the roster module, at the computing device, is configured to assign at least one weekly schedule and corresponding physical assets for each employee manually based on the employee preference data and the equipment care score aligned with the operational requirement data, and automatically based on the performance history. The weekly schedules include the daily shift and one or more upcoming shifts with corresponding tasks.

At yet another step, the roster management module, at the computing device, is configured to organize the daily shift and enable the scheduler to modify and finalize the daily shift based on last-minute updates received from the employee. At yet another step, the roster management module, at the computing device, is configured to publish the finalized daily shift schedule and task to the employee

At yet another step, the analytic module, at the computing device, is configured to analyze the performance of the employee to update a performance score. At yet another step, the analytic module, at the computing device, is configured to assess the condition of physical assets to update the proprietary equipment care score. At yet another step, the analytic module, at the computing device, is configured to manage workforce coaching, rewards, and evaluates key performance indicators (KPIs), including delivery accuracy, adherence to safety protocols, and teamwork.

The analytic module is configured to evaluate leave, time-off records, and availability data of the employee to ensure no shifts are assigned on zero-preference or unavailable days. The analytic module is further configured to verify driver qualification to confirm eligibility for assigned shifts based on the required certification or license type. The analytic module is further configured to ensure each employee is assigned to only one shift per day in compliance with labor and fatigue standards. The analytic module is further configured to ensure each employee is assigned within predefined capacity parameters corresponding to the specific shift, location, and time.

Further, the analytic module is configured to detect manually assigned shifts and ensure manual assignments remain unaltered during automated optimization processes. The analytic module is further configured to calculate total assigned working hours to enforce maximum limits defined by contractual and regulatory maximum working hour limits. The analytic module is further configured to verify overtime consent enforcement to avoid assigning shifts beyond standard working hours for employees who have not agreed to work overtime. The analytic module is further configured to ensure combined overtime hours across all the employee do not exceed the global company-defined limit.

The analytic module is further configured to ensure the employees do not exceed a predetermined number of consecutive working days and hours to prevent burnout and maintain compliance. The analytic module is further configured to perform two-week continuity analysis to detect excessive continuous work cycles. The analytic module is further configured to validate the integrity of shift-location-time mappings, excluding invalid configurations. Further, the analytic module is configured to analyze and balance overall workload distribution to ensure fair allocation of total hours and shifts among all available employees. The analytic module is further configured to enable automated computation of bonuses and penalty deductions based on predefined performance thresholds via a payroll system.

At yet another step, the summary generating module, at the computing device, is configured to generate one or more weekly summaries and performance reports based on the performance score and proprietary equipment care score. The notification module is further configured to notify the employee regarding changes made to finalized schedules and tasks. The notification module is further configured to generate one or more alerts to the scheduler regarding employee last-minute updates and compliance breaches. Further, the notification module is configured to maintain a complete history of all manual overrides performed on schedules.

The forecasting the scheduling process involves one or more steps. The automating the scheduling process at one step, involves automatically forecasting the upcoming shifts and tasks based on weekly summaries and performance reports. The forecasting the scheduling process involves at another step, involves evaluating the alignment between workforce availability and delivery objectives based on a visual and predictive staffing engine. The forecasting the scheduling process involves at yet another step, involves Identifying overstaffing, understaffing, and skill mismatches by comparing actual staffing levels with target shift coverage. The forecasting the scheduling process involves at yet another step, involves optimizing scheduling arrangements for maximum shift coverage and suggestions to reallocate shifts and relax scheduling constraints. forecasting the scheduling process involves at yet another step, involves generating staffing arrangements based on predefined variables, including overtime thresholds and preference override options.

Other objects, features and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF THE DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an environment of a system for automated work shift scheduling, according to an embodiment of the present invention.

FIG. 2 exemplarily illustrates a block diagram of the computing device, according to an embodiment of the present invention.

FIG. 3 illustrates a flowchart of a method for automated work shift scheduling, according to an embodiment of the present invention.

FIG. 4 illustrates a flowchart of a process of shift assignment, according to an embodiment of the present invention.

FIG. 5 illustrates a flowchart of a process of role-specific actions of scheduler and employer, according to an embodiment of the present invention.

FIG. 6 illustrates a flowchart of a process involved in dashboard navigation, according to an embodiment of the present invention.

FIG. 7 illustrates a screenshot of a user interface displaying a weekly schedule, one or more options to setup the weekly schedule, and a chatbot, according to an embodiment of the present invention.

FIG. 8 illustrates a screenshot of the user interface displaying a setup option comprising operations, engine, and teams, according to an embodiment of the present invention.

FIG. 9 illustrates a screenshot of the user interface displaying an existing operation and one or more options configured to create a new operation including operation type, shift type based on qualification, and location upon selecting the operation option, according to an embodiment of the present invention.

FIG. 10 illustrates a screenshot of the user interface enabling the selection of shift types to create the new operation, according to an embodiment of the present invention.

FIG. 11 illustrates a screenshot of the user interface enabling the selection of a loadout location for the new operation and providing the preview of selected shift type, according to an embodiment of the present invention.

FIG. 12 illustrates a screenshot of the user interface enabling the selection of a wave time for delivering the load in the new operation and providing the preview of selected shift type and loadout location, according to an embodiment of the present invention.

FIG. 13 illustrates a screenshot of the user interface enabling the selection of an arrival information for the new operation and providing the preview of selected shift type, loadout location, and wave time, according to an embodiment of the present invention.

FIG. 14 illustrates a screenshot of the user interface enabling to add a name for the new operation and the preview selected shift type, loadout location, wave time, and arrival information, according to an embodiment of the present invention.

FIG. 15 illustrates a screenshot of the user interface confirming the creation of the new operation by submitting the operation details and preview of the created new operation, according to an embodiment of the present invention.

FIG. 16 illustrates a screenshot of the user interface selection of shift type based on the qualification for the new operation, according to an embodiment of the present invention.

FIG. 17 illustrates a screenshot of the user interface selection of the location based on loadout and arrival of the new operation, according to an embodiment of the present invention.

FIG. 18 illustrates a screenshot of the user interface displaying one or more settings related to the permissions for a Last Mile Delivery partner (LMDP), according to an embodiment of the present invention.

FIG. 19 illustrates a screenshot of the user interface displaying one or more settings related to the preferences for the LMDP, according to an embodiment of the present invention.

FIG. 20 illustrates a screenshot of the user interface displaying one or more settings related to the addition setting provided for the LMDP, according to an embodiment of the present invention.

FIG. 21 illustrates a screenshot of the user interface displaying one or more settings related to the shift priority provided by the scheduler, according to an embodiment of the present invention.

FIG. 22 illustrates a screenshot of the user interface displaying one or more settings related to the default values provided by the scheduler, according to an embodiment of the present invention.

FIG. 23 illustrates a screenshot of the user interface displaying one

or more general settings, according to an embodiment of the present invention.

FIG. 24 illustrates a screenshot of the user interface displaying one or more analysis settings, according to an embodiment of the present invention.

FIG. 25 illustrates a screenshot of the user interface displaying unassigned shifts of a 43rd week, according to an embodiment of the present invention.

FIG. 26 illustrates a screenshot of the user interface displaying unassigned shifts and assigned shifts of a 42nd week, according to an embodiment of the present invention.

FIG. 27 illustrates a screenshot of the user interface displaying a daily roster, according to an embodiment of the present invention.

FIG. 28 illustrates a screenshot of the user interface displaying analysis option including a complete cover, a scenario, and an artificial intelligence (AI) assistant, according to an embodiment of the present invention.

FIG. 29 illustrates a screenshot of the user interface displaying the complete cover of the 43rd week, according to an embodiment of the present invention.

FIG. 30 illustrates a screenshot of the user interface enabling selection of the shift type to create a new scenario, according to an embodiment of the present invention.

FIG. 31 illustrates a screenshot of the user interface enabling to calculate the maximum shift coverage for the new scenario, according to an embodiment of the present invention.

FIG. 32 illustrates a screenshot of the user interface enabling to calculate the staffing changes for the new scenario, according to an embodiment of the present invention.

FIG. 33 illustrates a screenshot of the user interface enabling selection of the LMDP constrains and an override LMDP preferences for the new scenario, according to an embodiment of the present invention.

FIG. 34 illustrates a screenshot of the user interface selecting the priority of the week for the new scenario, according to an embodiment of the present invention.

FIG. 35 illustrates a screenshot of the user interface enabling to add a name for the new scenario, according to an embodiment of the present invention.

FIG. 36 illustrates a screenshot of the user interface providing the result of the new scenario, according to an embodiment of the present invention.

FIG. 37 illustrates a screenshot of the user interface displaying at least one query submitted to the artificial intelligence (AI) assistant, according to an embodiment of the present invention.

### DETAILED DESCRIPTION OF EXAMPLE EMBODIMENTS

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

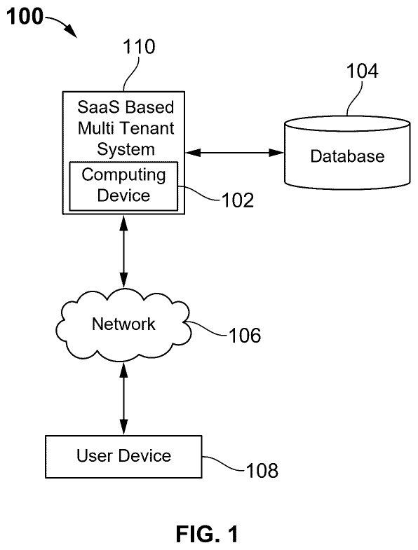

FIG. 1 exemplarily illustrates an environment 100 of a system for automated work shift management, according to an embodiment of the present invention. The system is executed in a Software as a Service (SaaS)-based multi-tenant platform or system 110. The system is configured to manage work shift scheduling to ensure tasks are completed efficiently and smoothly. The system comprises at least one computing device 102 and at least one database 104 in communication with the computing device 102 via a network 106. The system further comprises a user device 108 and the database 104 are in communication with the computing device 102 via the network 106.

The user device 108 is configured to provide an interface to access the services provided by the computing device 102. The interface, for example, an application that allows the user device 108 to wirelessly connect and access the computing device 102 via the network 106. The user device 108 includes, but not limited to, a desktop computer, a laptop computer, a mobile phone, a personal digital assistant, and the like. The user device 108 is associated with at least one user. The users comprise a scheduler, an employee, one or more super administrators, and one or more Distribution Service Providers (DSP) administrators. In one embodiment the employee could be a driver, also referred to as a last mile delivery partner (LMDP).

The network 106 generally represents one or more interconnected networks, over which the computing device 102 and the user device 108 could communicate with each other. The network 106 may include packet-based wide area networks (such as the Internet), local area networks (LAN), private networks, wireless networks, satellite networks, cellular networks, paging networks, and the like. A person skilled in the art will recognize that the network 106 may also be a combination of more than one type of network. For example, the network 106 may be a combination of a LAN and the Internet. In addition, the network 106 may be implemented as a wired network or a wireless network or a combination thereof.

In an example, the database 104 resides in the computing device 102. In another example, the database 104 resides separately from the computing device 102. Regardless of the location, the database 104 comprises a memory to store and organize data for use by the computing device 102. The database 104 is configured to store one or more operational requirement data received from the scheduler, an employee preference data received from the employee, and a performance history of the employee. The operational requirement data includes a template comprising shift types, shift timings, distribution times, required qualifications for each shift, locations, capacity limits per location, scheduling settings, feedback metrics, aggregate shift coverage by type and day, individual employee schedules, manual assignments, weekly targets, and required employee availability. The employee preference data includes preferred days of the week, preferred shift types, preferred work locations, preferred working hours, availability data, including leave and time-off requests, shift qualification levels, overtime consent, qualification updates, and any last-minute unavailability of the employees. The performance history of the employee comprises previous shift performance score, adherence to scheduled timings, overtime records, match confidence percentage, behavioral status, and equipment care scores derived from historical behavioral data of each employee with corresponding physical asset.

Further, the database 104 is configured with Application Programming Interfaces (APIs) to synchronize data with external systems. The external system includes but not limited to customer relationship management (CRM) systems or payroll systems. The API to connect with third-party applications for specific functions. The extensible API framework for third-party integrations includes payroll systems. The specific function including payroll, ERP (enterprise resource planning) system, and Global Positioning System (GPS) for a real-time traffic management system. The system also incorporates features such as incident reporting and advanced analytics, emphasizing the platform's extensibility and adaptability to evolving requirements. In one embodiment, the system is the Software as a Service (SaaS)-based multi-tenant system 110. Further, the system is configured to support multiple organizations with isolated data environments and configurable settings. The system offers modular features, enabling organizations to manage shifts, employees, and scenarios. The Software as a Service (SaaS)-based multi-tenant system 110 is configured to provide isolated data environments and customizable settings for each of a plurality of companies. The SaaS system 110 comprises a role-based access control (RBAC). The RBAC is configured to enable the scheduler to create at least one template for operational requirement, the employee to provide the employee preferences, the super admins to manage subscriptions and handle employee roles and permissions, and the distribution service provider (DSP) admins to manage operations and employee engagement.

The super admins have access to the system or platform, including managing subscriptions and handling the user roles and permissions. Further, DSP admins focus on operational workflows specific to the distribution service providers (DSP) including logistics, and employee schedules. The employee engages directly with tasks and schedules assigned to the employee. Further, the employee is enabled to access the task lists, update schedule, submit reports, and track their work hours. The system further facilitates scenario planning and provides simulation features. The system is further configured to provide dashboard-centric design with modular sections for managing shifts, employees, and scenarios.

In one embodiment, the computing device 102 is at least one of a server, a general-purpose computer, a special-purpose computer, a workstation, a desktop, a laptop, a tablet, a mobile phone, a mainframe, a supercomputer, and a server farm. Although the computing device 102 is illustrated as a single device, the functions performed by the computing device 102 could be performed using any suitable number of computing devices 102.

The computing device 102 is configured to receive the operational requirement data and the employee preference data via the user device 108. The computing device 102 is further configured to assign at least one weekly schedule and corresponding physical assets for each employee manually based on the employee preference data and the equipment care score aligned with the operational requirement data, and automatically based on the performance history. The physical assets include, but not limited to, walker, step van, parcel van, vans, hand trucks, devices, uniforms. The weekly schedules include a daily shift and one or more upcoming shifts with corresponding tasks.

The computing device 102 is configured to organize the daily shift. The computing device 102 is further configured to enable the scheduler to modify and finalize the daily shift based on last-minute updates received from the employee. The computing device 102 is further configured to publish the finalized daily shift schedule and task to the employee. The computing device 102 is further configured to balance one or more parameters for producing optimized and equitable scheduling outcomes. The parameters include minimizing unfilled shifts and over-assigned hours, maximizing driver satisfaction with respect to both preferred days and shifts, and giving priority to preferred locations during the rostering process. Further, the computing device 102 is configured to encourage time consistency with the previous week's shifts, reduce overtime penalties, and reward familiarity by providing bonuses for frequently assigned locations. The scheduler is a person associated with the company management. Further, the operational requirement data is linked with relevant data to support an ongoing day shift. The computing device 102 is further configured to enable the scheduler to set the required scheduling settings and parameters for employee preference data and default settings.

The computing device 102 is further configured to display a screen for one or more weekly schedules. The computing device 102 is configured to enable the scheduler to enter shift data by dragging shift types into a new row. Further, the computing device 102 is configured to enable the scheduler to select the overstaffing shift or the standby shift. Further, the computing device 102 is configured to allow the scheduler to enter known shift targets for specific days of the week. if the targets are same for more than one day then the scheduler enters data once and apply them across all relevant days. Further, the process of entering shift data is repeated for additional shift types as needed. In one embodiment, the computing device 102 is configured to enable the scheduler to schedule shifts for multiple roles including walker, parcel van, and step van.

The computing device 102 is further configured to display a screen for creating the weekly schedule. The computing device 102 is further configured to provide the weekly scheduling screen with a designated space for feedback metrics, aggregate shift coverage by type and day, and individual employee schedules and availability of employee. The designated spaces are updated based on the changes in populated shifts and enable the scheduler to continue entering and adjusting shifts manually as needed. Further, the computing device 102 is configured to enable the scheduler to update or fill shifts manually as desired. Further, the computing device 102 is configured to allow the scheduler to access the scheduling settings at any time to adjust parameters and update or fill remaining shifts based on the settings and availability of the employee. Further, the changes are assisted using color-coded indicators to show the unfilled shifts by type and day. The computing device 102 is further configured to enable the scheduler to publish the schedule when the information is finalized or satisfied. The computing device is configured to send the published schedule to the employee. Additionally, the weekly scheduling screen is configured to enable the scheduler to delete and re-run the scheduler or return to make further adjustments in the above steps later.

The computing device 102 is configured to display a screen to run one or more daily roster. The computing device 102 is configured to generate the weekly schedule by balancing organizational goals with individual driver or employee preferences. The computing device 102 is configured to enable the scheduler to run the daily roster to organize the daily shift schedule. Further, the computing device 102 is configured to enable the scheduler to scroll the screen to navigate to one or more upcoming shifts and the daily shifts. Further, the daily shifts and one or more upcoming shifts are pre-populated in each row based on the weekly schedule. Further, the computing device 102 is configured to enable the scheduler to select distribution locations and allocate shifts by dragging and dropping the selected location into the appropriate columns. The computing device 102 is configured to further allow the scheduler to continuously allocate the shifts based on the type and location of the shift until all shifts are assigned for either one or another employee. Further, the computing device 102 is configured to allow the scheduler to run the algorithm daily. Further, the computing device 102 is configured to roster all allocated shifts by appending time and location data to the pre-filled shifts according to established employee preferences.

The computing device 102 is configured to enable the scheduler to view or edit daily shifts based on the weekly schedule. Further, the weekly schedule comprises the row representing a different shift type and a column representing the days. Further, the computing device 102 is configured to enable the scheduler to view and modify the weekly schedule for days that have not been finalized (at least day+1). Further, the available or unfilled tiles are color-coded to indicate a status that ranges from fully rostered and filled to the tiles containing any combination of unfilled or unrostered shifts. Further, the entry into each tile will display further tiles for unrostered and unfilled shifts (if any of either), as well as one tile with shift totals for each distribution location and time with rostered shifts. Further, the computing device 102 is configured to enable the scheduler to schedule, unschedule, roster, unroasted, add, or remove shifts based on business needs and employee preferences. The computing device 102 is further configured to enable the scheduler to broadcast an open shift to available employees and initiate a shift request. Further, the tiles are indicated with a green color code when all shifts for a day are fully rostered and filled. Further, the computing device 102 is configured to enable the scheduler to lock the day to finalize the schedule and send updates to employees. Once the schedule is finalized, that day's column joins the other inaccessible days already completed that week.

The computing device 102 is configured to analyze the performance of the employee to generate a performance score and assess the condition of physical assets to update the proprietary equipment care score. The computing device 102 is further configured to manage workforce coaching and rewards, and evaluates key performance indicators (KPIs), including delivery accuracy, adherence to safety protocols, and teamwork. The coaching workflow comprises a note-based history and provides escalation triggers to initiate formal offboarding or remediation processes for underperforming employee. The coaching workflow is a structured process generally involves setting goals, assessing current performance, creating an action plan, and reviewing outcomes.

The computing device 102 comprises one or more scenario setups configured to evaluate the effect of incorporating changes into upcoming shifts and tasks. The changes comprise the changes made to the operational requirement data, shift type, employee, and location. Further, the computing device 102 is configured to determine whether the changes produce improved scheduling results.

The computing device 102 further comprises a complete cover. The complete cover comprises one or more graphs configured to provide real-time insight into shift coverage efficiency and staffing optimization, including daily shift coverage, overstaffed and understaffed shifts, locations, employees available for overtime (OT), imbalanced qualification distributions, and missed opportunities resulting from restrictive day or shift preferences. The understaffed shifts employees are categorized according to overtime preferences, including preferred overtime (OT), reasonable overtime (OT), tolerable overtime (OT), and intolerable overtime (OT).

The computing device 102 is configured to evaluate leave, time-off records, and availability data of the employee to ensure no shifts are assigned on zero-preference or unavailable days. The computing device 102 is further configured to verify driver qualification to confirm eligibility for assigned shifts based on the required certification or license type. The computing device 102 is further configured to ensure each employee is assigned to only one shift per day in compliance with labor and fatigue standards. The computing device 102 is further configured to ensure each employee is assigned within predefined capacity parameters corresponding to the specific shift, location, and time.

Further, the computing device 102 is configured to detect manually assigned shifts and ensure manual assigned shifts remain unaltered during automated optimization processes. The computing device 102 is further configured to calculate total assigned working hours to enforce maximum limits defined by contractual and regulatory maximum working hour limits. The computing device 102 is further configured to verify overtime consent enforcement to avoid assigning shifts beyond standard working hours for employees who have agreed to work overtime. The computing device 102 is further configured to ensure combined overtime hours across all the employee do not exceed the global company-defined limit.

The computing device 102 is further configured to ensure the employees do not exceed a predetermined number of consecutive working days and hours to prevent burnout and maintain compliance. The computing device 102 is further configured to perform two-week continuity analysis to detect excessive continuous work cycles. The computing device 102 is further configured to validate the integrity of shift-location-time mappings, excluding invalid configurations. Further, the computing device 102 is configured to analyze and balance overall workload distribution to ensure fair allocation of total hours and shifts among all available employees. The computing device 102 is further configured to enable automated computation of bonuses and penalty deductions based on predefined performance thresholds via a payroll system. The computing device 102 is configured to generate one or more weekly summaries and performance reports based on the performance score and proprietary equipment care score. In one embodiment, the performance reports include a last mile delivery partner (LMDP)-level performance reports and company-wide newsletters.

The computing device 102 is configured to verify the attendance of the employee at one or more depot entry points based on one or more attributes. The attributes include, but not limited to, uniform compliance, identity recognition, and behavioral analysis via a camera. The computing device 102 is further configured to record the identity recognition to match confidence level of the employee and flag a failed verification attempt. The computing device 102 is further configured to enable a supervisor to manually verify the employee following the failed verification. The computing device 102 is further configured to record the action of the supervisor along with a timestamp. The computing device 102 is further configured to enable the supervisors to validate asset condition at check-in and return points. Further, the computing device 102 is configured to generate one or more incident tickets for lost or damaged assets, missed handovers, or incomplete routes. The computing device 102 is configured to assign and transmit equipment care scores to central operational dashboards.

The computing device 102 is configured to notify the employee regarding changes made to finalized schedules and tasks. The computing device 102 is further configured to generate one or more alerts to the scheduler regarding employee last-minute updates and compliance breaches. Further, the computing device 102 is configured to maintain a complete history of all manual overrides performed on schedules. The computing device 102 is configured to track the status of physical assets assigned to the employees. The status includes active, in repair, or suspended. The computing device 102 is further configured to maintain a log of equipment issuance and return activities. The computing device 102 is further configured to automatically detect and flag any asset with historical damage for corresponding penalty deductions.

The computing device 102 is configured to automatically forecast the upcoming shifts and tasks based on weekly summaries and performance reports. The computing device 102 is further configured to evaluate the alignment between workforce availability and delivery objectives based on a visual and predictive staffing engine. The computing device 102 is further configured to identify overstaffing, understaffing, and skill mismatches by comparing actual staffing levels with target shift coverage. The computing device 102 is further configured to optimize scheduling arrangements for maximum shift coverage and suggestions to reallocate shifts and relax scheduling constraints. Further, the computing device 102 is configured to generate staffing arrangements based on predefined variables, including overtime thresholds and preference override options.

The computing device 102 is configured to display a screen for ongoing schedules. The computing device 102 is further configured to forecast and predict the number of drivers or the employees required in future needs and overtime requirements. The forecasting aims to analyze the existing availability of the employee using standard settings. Further, calculate the existing availability of drivers and employees based on current week shift targets or 6- or 13-week averages. The existing availability of drivers and employees is calculated to determine the number of the employee available to work. Further, the forecasting aids to calculate the maximum shift coverage based on provided settings including weekly hires by qualification and the number of weeks into the future. The maximum shift coverage is calculated to determine the number of the drivers and employees required in the future. Further, the forecasting aids to calculate the number of hires needed based on the hiring or attrition taken place over time and considers the data of shift targets and weeks into the future.

The computing device 102 is further configured to provide a universal setting for the user to adjust input constraints such as overtime and respect for driver preference, or to use defaults, before running forecaster. Further, the computing device 102 is configured to provide a desired choice with universal feedback. The universal feedback includes, but not limited to, the availability of maximum average days, total overtime (OT), average hours per employee, and various employee's preference scores. Further, the computing device 102 is configured to provide a form of metric that enhance the process of scheduling the shifts. The form of metrics comprises an availability ratio and an employee feedback score. The availability ratio conveys the relationship between employee availability and the total number of shifts required. Further, the employee feedback score provides a weekly quantification of the percentage of the optimally desired schedule achieved for each employee. Further, the computing device 102 is configured to enable the scheduler to adjust settings and data based on the employee preferences and availability data. The computing device 102 is further configured to enable the scheduler to re-run the process at once or across time to obtain updated information and adjust the shift.

The computing device 102 is configured to enable the employee or the driver to set a preference setting. The computing device 102 is configured to enable the employee or the driver to set and manipulate the schedule based on the employee preferences via the user device 108. Further, the driver or the employee requires management approval to manipulate and set the schedule. Further, the employee preference requests are populated into the screens accompanying scheduling screens for ongoing engagement and resolution. The computing device 102 is configured to enable the user to send a time off request for one or more days after completion of the current published schedule via the user device 108. Further, the time off request is combined with preference requests in the manager's queue for ongoing resolution. The computing device 102 is configured to enable the user to accept, reject, or ignore the open shift request.

The computing device 102 is further configured to enable the scheduler to assign an open shift request for one or more employees. The computing device 102 is further configured to enable the driver or employee to accept, reject, or ignore the request. Further, the request disappears for other drivers or employees once the shift is accepted and the notification is sent to the drivers or employees via the user device 108. The notification notifies employees about the assigned shifts, changes in scheduling, and any necessary updates via the user device 108. Further, the system is under security measures implemented to protect sensitive information and manage employee access. The sensitive information includes, but not limited to, incident reports and employee data. Once the weekly schedule is executed, the computing device 102 is configured to display a final driver-shift-location assignments, percentage of shift coverage, total working hours per driver, overtime utilization statistics, preference satisfaction ratios, consecutive workday, and hour summaries, and underfilled or overfilled shift analysis.

The computing device 102 further comprises one or more artificial intelligence (AI) assistants. The AI assistant is configured to provide answers for one or more workforce-related queries. The queries are related to employee attendance, shift coverage, performance metrics, and summaries, and the frequently used queries are stored as reusable dashboard widgets for rapid access. For example, the queries include, but not limited to, “Who was late more than twice this week?”, “download the weekly performance summary”, and “Download scorecards by zone”. The answers are provided in one or more formats, including spreadsheets, charts, graphs, and trendlines. At least one AI assistant is implemented as a chatbot comprising a text messaging feature and a voice call function. The chatbot is configured to assist the user with on-screen issues by providing interactive guidance, troubleshooting steps, and contextual recommendations based on the current user interface.

Structurally, the relevant data is stored across multiple interrelated tables. An assignment table maintains foreign keys referencing the shift type, and delivery date, and an identifier from this table, once published, persists throughout the remainder of the process. A roster assignment table uses the assignment table identifier as a central reference and further includes a foreign key for a roster slot defining time and location, wherein this table remains mutable to accommodate user-driven rostering changes. Reduction and addition tables operate as separate ancillary assignment tables that record post-publication modifications, including additions and reductions, each referencing the original assignment table identifier and storing process-specific details. An arrival table similarly references the assignment table identifier and records arrival time alongside scheduled time to determine on-time status. Collectively, this data structure enables independence of roster-level data while maintaining an immutable audit trail that tracks the lifecycle of a schedule from the original assignment through eventual outcomes, including on-time attendance, callouts, call-ins, tardiness, and shift modifications.

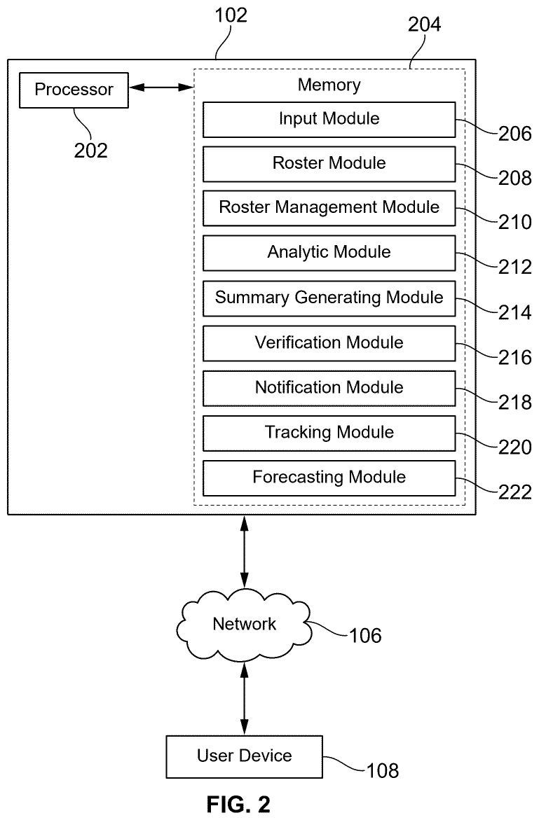

FIG. 2 exemplarily illustrates a block diagram of the computing device 102, according to an embodiment of the present invention. The computing device 102 comprises one or more processors 202 and one or more memories 204. The processor 202 is configured to execute one or more program modules, and the memory 204 is configured to store the set of program modules. The program modules comprise an input module 206, a roster module 208, a roster management module 210, an analytic module 212, a summary generating module 214, a verification module 216, a notification module 218, a tracking module 220, and a forecasting module 222.

The input module 206 is configured to receive the operational requirement data and the employee preference data via the user device 108. The roster module 208 is configured to assign at least one weekly schedule and corresponding physical assets for each employee manually based on the employee preference data and the equipment care score aligned with the operational requirement data, and automatically based on the performance history. The weekly schedules include the daily shift and one or more upcoming shifts with corresponding tasks.

The roster management module 210 is configured to organize the daily shift. The roster management module 210 is further configured to enable the scheduler to modify and finalize the daily shift based on last-minute updates received from the employee. The roster management module is configured to publish the finalized daily shift schedule and task to the employee. The roster management module 210 is further configured to balance one or more parameters for producing optimized and equitable scheduling outcomes. The parameters include minimizing unfilled shifts and over-assigned hours, maximizing driver satisfaction with respect to both preferred days and shifts, and giving priority to preferred locations during the rostering process. Further, the roster management module 210 is configured to encourage time consistency with the previous week's shifts, reduce overtime penalties, and reward familiarity by providing bonuses for frequently assigned locations.

The analytic module 212 is configured to analyze the performance of the employee to generate a performance score and assess the condition of physical assets to update the proprietary equipment care score. The analytic module 212 is further configured to manage coaching workflow and rewards, and evaluates key performance indicators (KPIs), including delivery accuracy, adherence to safety protocols, and teamwork. The workforce coaching workflow comprises a note-based history and provides escalation triggers to initiate formal offboarding or remediation processes for underperforming employee. The analytic module 212 comprises one or more scenario setups configured to evaluate the effect of incorporating changes into upcoming shifts and tasks. The changes comprise the changes made to the operational requirement data, shift type, employee, and location. Further, the analytic module 212 is configured to determine whether the changes produce improved scheduling results.

The analytic module 212 further comprises a complete cover. The complete cover comprises one or more graphs configured to provide real-time insight into shift coverage efficiency and staffing optimization, including daily shift coverage, overstaffed and understaffed shifts, locations, employees available for overtime (OT), imbalanced qualification distributions, and missed opportunities resulting from restrictive day or shift preferences. The understaffed shifts employees are categorized according to overtime preferences, including preferred overtime, reasonable overtime, tolerable overtime, and intolerable overtime.

The analytic module 212 is configured to evaluate leave, time-off records, and availability data of the employee to ensure no shifts are assigned on zero-preference or unavailable days. The analytic module 212 is further configured to verify driver qualification to confirm eligibility for assigned shifts based on the required certification or license type. The analytic module 212 is further configured to ensure each employee is assigned to only one shift per day in compliance with labor and fatigue standards. The analytic module 212 is further configured to ensure each employee is assigned within predefined capacity parameters corresponding to the specific shift, location, and time.

Further, the analytic module 212 is configured to detect manually assigned shifts and ensure manual assignments remain unaltered during automated optimization processes. The analytic module 212 is further configured to calculate total assigned working hours to enforce maximum limits defined by contractual and regulatory maximum working hour limits. The analytic module 212 is further configured to verify overtime consent enforcement to avoid assigning shifts beyond standard working hours for employees who have not agreed to work overtime. The analytic module 212 is further configured to ensure combined overtime hours across all the employee do not exceed the global company-defined limit.

The analytic module 212 is further configured to ensure the employees do not exceed a predetermined number of consecutive working days and hours to prevent burnout and maintain compliance. The analytic module 212 is further configured to perform two-week continuity analysis to detect excessive continuous work cycles. The analytic module 212 is further configured to validate the integrity of shift-location-time mappings, excluding invalid configurations. Further, the analytic module 212 is configured to analyze and balance overall workload distribution to ensure fair allocation of total hours and shifts among all available employees. The analytic module 212 is further configured to enable automated computation of bonuses and penalty deductions based on predefined performance thresholds via a payroll system. The summary generating module 214 is configured to generate one or more weekly summaries and performance reports based on the performance score and proprietary equipment care score.

The verification module 216 is configured to verify the attendance of the employee at one or more depot entry points based on one or more attributes. The verification module 216 is configured to record the identity recognition to match confidence level of the employee and flag a failed verification attempt. The verification module 216 is further configured to enable a supervisor to manually verify the employee following the failed verification. The verification module 216 is further configured to record the action of the supervisor along with a timestamp. The verification module 216 is further configured to enable the supervisors to validate asset condition at check-in and return points. Further, the verification module 216 is configured to generate one or more incident tickets for lost or damaged assets, missed handovers, or incomplete routes. The verification module 216 is configured to assign and transmit equipment care scores to central operational dashboards. In some embodiments, each verification attempt generates a confidence score and is logged in an immutable, access-controlled audit trail. Supervisor overrides require mandatory reason codes and are permanently recorded. Low-confidence outcomes within predefined tolerances do not require overrides, but all override actions remain visible for managerial and compliance review, ensuring full transparency and traceability.

The notification module 218 is configured to notify the employee regarding changes made to finalized schedules and tasks. The notification module 218 is further configured to generate one or more alerts to the scheduler regarding employee last-minute updates and compliance breaches. Further, the notification module 218 is configured to maintain a complete history of all manual overrides performed on schedules. The tracking module 220 is configured to track the status of physical assets assigned to the employees. The status includes active, in repair, or suspended. The tracking module 220 is further configured to maintain a log of equipment issuance and return activities. The tracking module 220 is further configured to automatically detect and flag any asset with historical damage for corresponding penalty deductions.

The forecasting module 222 is configured to automatically forecast the upcoming shifts and tasks based on weekly summaries and performance reports. The forecasting module 222 is further configured to evaluate the alignment between workforce availability and delivery objectives based on a visual and predictive staffing engine. The forecasting module 222 is further configured to identify overstaffing, understaffing, and skill mismatches by comparing actual staffing levels with target shift coverage. The forecasting module 222 is further configured to optimize scheduling arrangements for maximum shift coverage and suggestions to reallocate shifts and relax scheduling constraints. Further, the forecasting module 222 is configured to generate staffing arrangements based on predefined variables, including overtime thresholds and preference override options. In another embodiment, the forecasting module or scenario planning module 222 produces two outputs: aggregate staffing capacity under defined constraints and a roadmap of hires or terminations required to meet specified shift targets. This tool is not time-bound; users may manually average results across any chosen period. Scenario outputs are not versioned and cannot be directly applied to live scheduling. Only aggregate figures persist, while underlying shift-level data is intentionally not stored. Henceforth, the system does not provide confidence intervals or sensitivity analysis, prioritizing instant re-execution instead.

The computing device 102 is configured to create and assign the shift effectively, enables to perform assignment manually, or a combination of both. The computing device 102 is further configured to enable segregation of employee based on shift types, employee preferences, availability, and qualification levels. The computing device 102 is further configured to manage the shift scheduling according to the updated preferences provided by the employee. The computing device 102 is further configured to create, test, and evaluate different scheduling shifts or outcomes based on varying inputs or conditions. The computing device 102 is further configured to view the finalized, published and assigned shift.

The method of the system for automated work shift scheduling comprises a two phase that includes a first phase and a second phase. The first phase comprises an assignment phase that schedules shift by assigning dates and shift types based on initial demand data. In assignment phase, the system is configured to schedule the shifts based on available information about delivery needs. The available information about delivery needs includes, but not limited to, the date and type of shift required. The assignment phase considers variables like historical delivery trends, seasonal fluctuations, and initial customer demand forecasts. By focusing on assigning shifts with only the most necessary initial information, the system provides early scheduling which allows the users to plan resources effectively.

The second phase comprises a rostering phase that schedules specific times and locations for the shifts as additional data is available. As the date of the assigned shift approaches, the system gathers additional data about specific time slots and delivery locations. The rostering phase optimizes the assignment by determining the best time slots and locations for each shift, adjusting for updated demand and resource availability. The rostering phase is crucial for adapting to changes that were not foreseeable during the assignment phase, such as last-minute delivery requests or changes in route availability. Further, the rostering phase ensures that all shifts are accurately filled with the most current information.

Each phase is useful both to the user and the recipient of this information, and is required due to the unique demands of last-mile distribution, Further, in some aspects of customer demand information are less well known in advance. Further, the system considers a unique set of preferences and constraints, and the rostering is dependent on the details of the assignment. The unique combination of constraints, weights, and variables considered that are specific to the last-mile delivery industry. Further, the algorithm solves the unique challenge of scheduling staff in advance with only part of the information available, including date and type, and is run separately to fill in details, including the time and the location when they become available. The two-phase process enables the scheduling system to make preliminary assignments with limited data and adjust the schedule as new information becomes available. Thus, the two-phase process is configured to provide a dynamic and adaptable scheduling solution for industries with variable demand patterns.

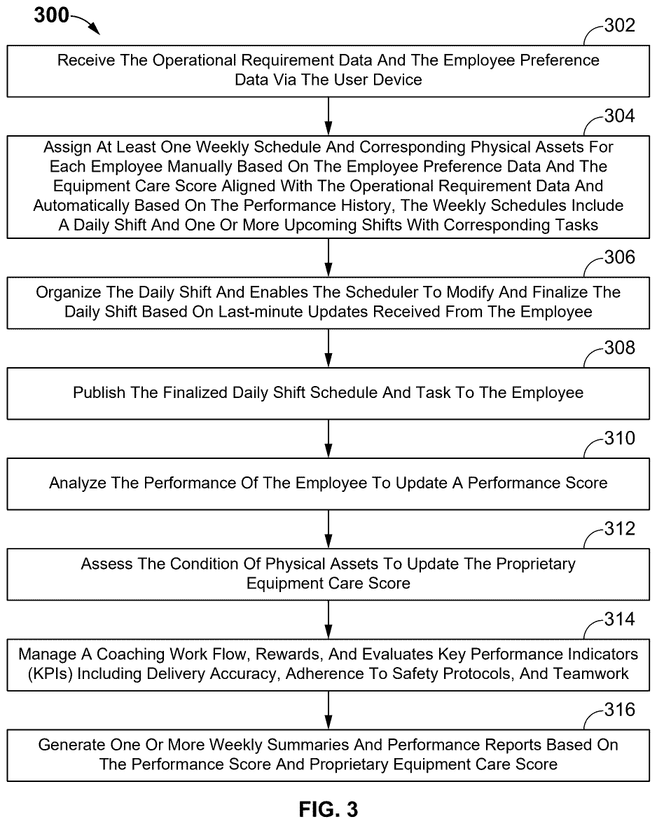

FIG. 3 illustrates a flowchart 300 of a method for automated work shift management, according to an embodiment of the present invention. The method is incorporated in the system comprising at least one computing device 102 and at least one database 104 in communication with the computing device 102 via the network 106. The system further comprises the user device 108 and the database 104 are in communication with the computing device 102 via the network 106. The user device 108 is associated with at least one user. The users comprise a scheduler, an employee, one or more super administrators, and one or more distribution service providers (DSP) administrators.

The database 104 is configured to store one or more operational requirement data received from the scheduler, an employee preference data received from the employee, and a performance history of the employee. The operational requirement data includes a template comprising shift types, shift timings, distribution times, required qualifications for each shift, locations, capacity limits per location, scheduling settings, feedback metrics, aggregate shift coverage by type and day, individual employee schedules, manual assignments, weekly targets, and required employee availability. The employee preference data includes preferred days of the week, preferred shift types, preferred work locations, preferred working hours, availability data including leave and time-off requests, shift qualification levels, overtime consent, qualification updates, and any last-minute unavailability of the employees. The performance history of the employee comprises previous shift performance score, adherence to scheduled timings, overtime records, match confidence percentage, behavioral status, and equipment care scores derived from historical behavioral data of each employee with corresponding physical asset.

The computing device 102 comprises at least one memory 204 configured to store the set of program modules and at least one processor 202 configured to execute one or more program modules. The program modules comprise the input module 206, the roster module 208, the roster management module 210, the analytic module 212, the summary generating module 214, the verification module 216, the notification module 218, the tracking module 220, and the forecasting module 222.

At step 302, the input module 206, at the computing device 102, is configured to receive the operational requirement data and the employee preference data via the user device 108. At step 304, the roster module 208, at the computing device 102, is configured to assign at least one weekly schedule and corresponding physical assets for each employee manually based on the employee preference data and the equipment care score aligned with the operational requirement data, and automatically based on the performance history. The weekly schedules include a daily shift and one or more upcoming shifts with corresponding tasks.

At step 306, the roster management module 210, at the computing device 102, is configured to organize the daily shift and enable the scheduler to modify and finalize the daily shift based on last-minute updates received from the employee. At step 308, the roster management module 210, at the computing device 102, is configured to publish the finalized daily shift schedule and task to the employee.

At step 310, the analytic module 212, at the computing device 102, is configured to analyze the performance of the employee to update a performance score. At step 312, the analytic module 212, at the computing device 102, is configured to assess the condition of physical assets to update the proprietary equipment care score. At step 314, the analytic module 212, at the computing device 102, is configured to manage coaching workflow, rewards, and evaluates key performance indicators (KPIs), including delivery accuracy, adherence to safety protocols, and teamwork.

The analytic module 212 is configured to evaluate leave, time-off records, and availability data of the employee to ensure no shifts are assigned on zero-preference or unavailable days. The analytic module 212 is further configured to verify driver qualification to confirm eligibility for assigned shifts based on the required certification or license type. The analytic module 212 is further configured to ensure each employee is assigned to only one shift per day in compliance with labor and fatigue standards. The analytic module 212 is further configured to ensure each employee is assigned within predefined capacity parameters corresponding to the specific shift, location, and time.

Further, the analytic module 212 is configured to detect manually assigned shifts and ensure manual assignments remain unaltered during automated optimization processes. The analytic module 212 is further configured to calculate total assigned working hours to enforce maximum limits defined by contractual and regulatory maximum working hour limits. The analytic module 212 is further configured to verify overtime consent enforcement to avoid assigning shifts beyond standard working hours for employees who have not agreed to work overtime. The analytic module 212 is further configured to ensure combined overtime hours across all the employee do not exceed the global company-defined limit.

The analytic module 212 is further configured to ensure the employees do not exceed a predetermined number of consecutive working days and hours to prevent burnout and maintain compliance. The analytic module 212 is further configured to perform two-week continuity analysis to detect excessive continuous work cycles. The analytic module 212 is further configured to validate the integrity of shift-location-time mappings, excluding invalid configurations. Further, the analytic module 212 is configured to analyze and balance overall workload distribution to ensure fair allocation of total hours and shifts among all available employees. The analytic module 212 is further configured to enable automated computation of bonuses and penalty deductions based on predefined performance thresholds via a payroll system.

At step 316, the summary generating module 214, at the computing device 102, is configured to generate one or more weekly summaries and performance reports based on the performance score and proprietary equipment care score. The notification module 218 is further configured to notify the employee regarding changes made to finalized schedules and tasks. The notification module 218 is further configured to generate one or more alerts to the scheduler regarding employee last-minute updates and compliance breaches. Further, the notification module 218 is configured to maintain a complete history of all manual overrides performed on schedules.

The forecasting the scheduling process involves one or more steps. The automating the scheduling process at one step, involves automatically forecasting the upcoming shifts and tasks based on weekly summaries and performance reports. The forecasting the scheduling process involves at another step, involves evaluating the alignment between workforce availability and delivery objectives based on a visual and predictive staffing engine. The forecasting the scheduling process involves at yet another step, involves Identifying overstaffing, understaffing, and skill mismatches by comparing actual staffing levels with target shift coverage. The forecasting the scheduling process involves at yet another step, involves optimizing scheduling arrangements for maximum shift coverage and suggestions to reallocate shifts and relax scheduling constraints. forecasting the scheduling process involves at yet another step, involves generating staffing arrangements based on predefined variables, including overtime thresholds and preference override options.

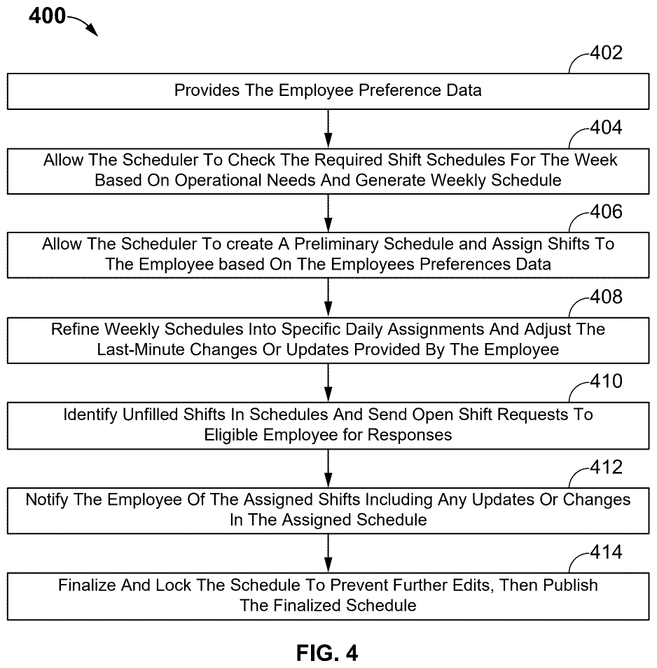

FIG. 4 illustrates a flowchart 400 of a process of shift assignment, according to an embodiment of the present invention. At step 402, the system is configured to provide the employee preference data. At step 404, the system is configured to allow the scheduler to check the required shift schedules for the week based on operational needs and generate the weekly schedule. At step 406, the system is further configured to allow the scheduler to create a preliminary schedule and assign shifts to the employee based on the employee preference data. At step 408, the system is further configured to refine weekly schedules into specific daily assignments and adjust the last-minute changes or updates provided by the user. At step 410, the system is configured to identify unfilled shifts in schedules and send open shift requests to the eligible employee for responses. At step 412, the system is configured to notify the employee of the assigned shifts, including any updates or changes in the assigned schedule. At step 414, the system is configured to finalize and lock the schedule to prevent further edits, and then the finalized schedule is published.

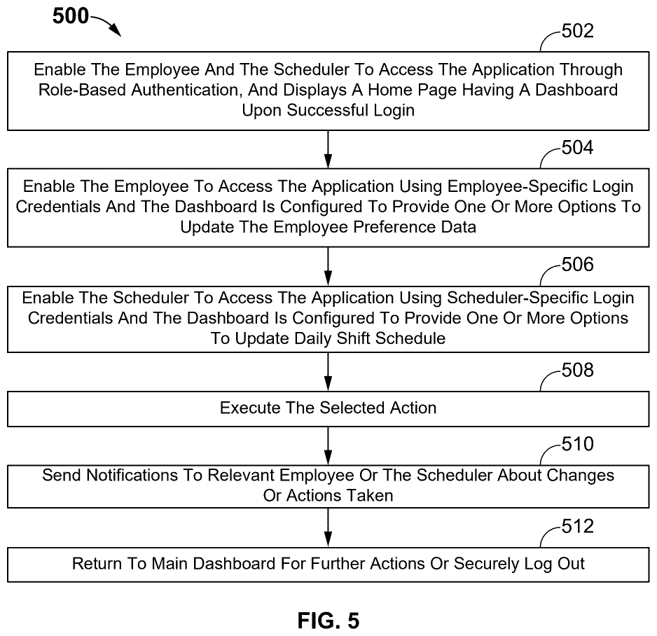

FIG. 5 illustrates a flowchart 500 of a process of role-specific actions of scheduler and employer, according to an embodiment of the present invention. At step 502, the system is configured to enable the employee and the scheduler to access the application through role-based authentication, and displays a home page having a dashboard upon successful login. At step 504, the system is further configured to enable the employee to access the application using employee-specific login credentials and the dashboard is configured to provide one or more options to update the employee preference data. The option allows the employee to view the schedule, check assigned shifts, daily roster, and update preferences, including modifying availability, shift type, week, location, or time to work. Further, the system is configured to provide the options allowing the employee to respond to notifications after the daily shift is assigned. Further, the options include accepting, rejecting, or ignoring the shift requests, and requesting time off. At step 506, the system is further configured to enable the scheduler to access the application using scheduler-specific login credentials, and the dashboard is configured to provide one or more options to update the daily shift, including weekly schedule management, daily rostering, forecasting, and notifications are displayed to scheduler. At step 508, the selected action is executed. At step 510, the system is configured to send the notifications to relevant employees or the scheduler about changes or actions taken. At step 512, the system is configured to enable the employee and the scheduler to return to the main dashboard for further actions or to securely log out.

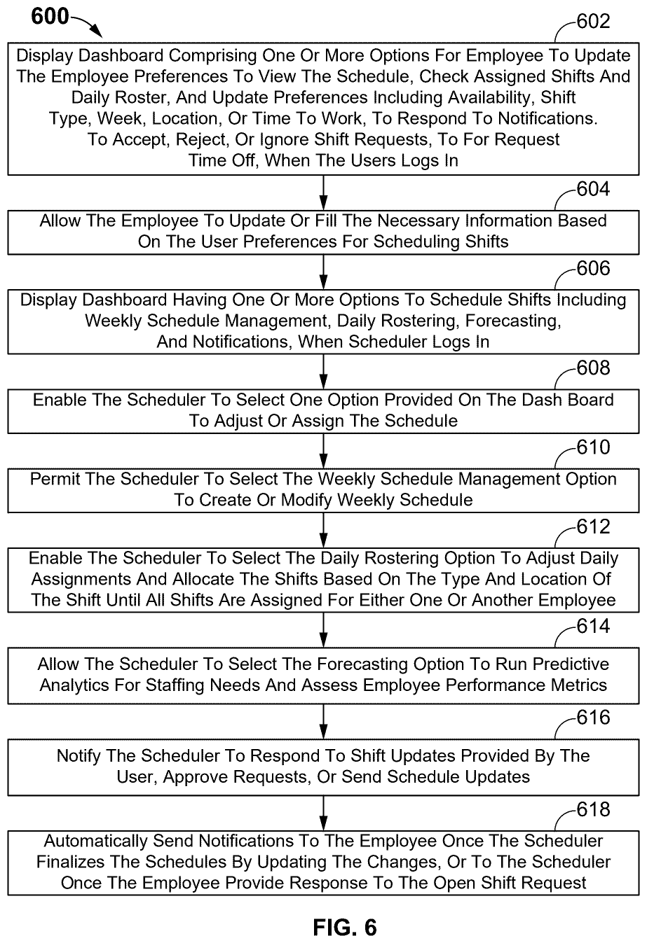

FIG. 6 illustrates a flowchart 600 of a process involved in dashboard navigation, according to an embodiment of the present invention. At step 602, the system is configured to display the dashboard comprising one or more option for the employee to update the employee preference. At least one option is configured to allow the employee to view the schedule, check assigned shifts, daily roster, and update employee preferences. The employee preferences include availability, shift type, week, location, or time to work. At least one option is configured to allow the employee to respond to notifications. At least one option is configured to enable the employee to accept, reject, or ignore shift requests and to request time off. At step 604, the dashboard is configured to enable the employee to update or fill the necessary information based on the employee preferences. At step 606, the dashboard comprises one or more options configured to schedule the shifts, including weekly schedule management, daily rostering, forecasting, and notifications.

At step 608, the dashboard is configured to enable the scheduler to select one option provided on the dashboard to adjust or assign the schedule. At step 610, the dashboard is configured to permit the scheduler to select the weekly schedule management option to create or modify the weekly schedule. At step 612, the dashboard is configured to enable the scheduler to select the daily rostering option to adjust daily assignments and allocating the shifts based on the type and location of the shift until all shifts are assigned for either one or another employee. At step 614, the dashboard is configured to allow the scheduler to select the forecasting option to run predictive analytics for staffing needs and assess employee performance metrics. Further, the forecasting option is configured to allow the scheduler to analyze the existing availability of drivers, maximum shift coverage, and number of hires needed to complete the given targets.

At step 616, the dashboard is configured to notify the scheduler to respond to shift updates provided by the user, approve requests, or send schedule updates. Further, the notification provides the update of the system in real-time to reflect the latest information. At step 618, the dashboard is configured to automatically send the notifications to the employee once the scheduler finalizes the schedules by updating the changes. Further, the dashboard is configured to send the notification to the scheduler once the employee provides the response to the open shift request.

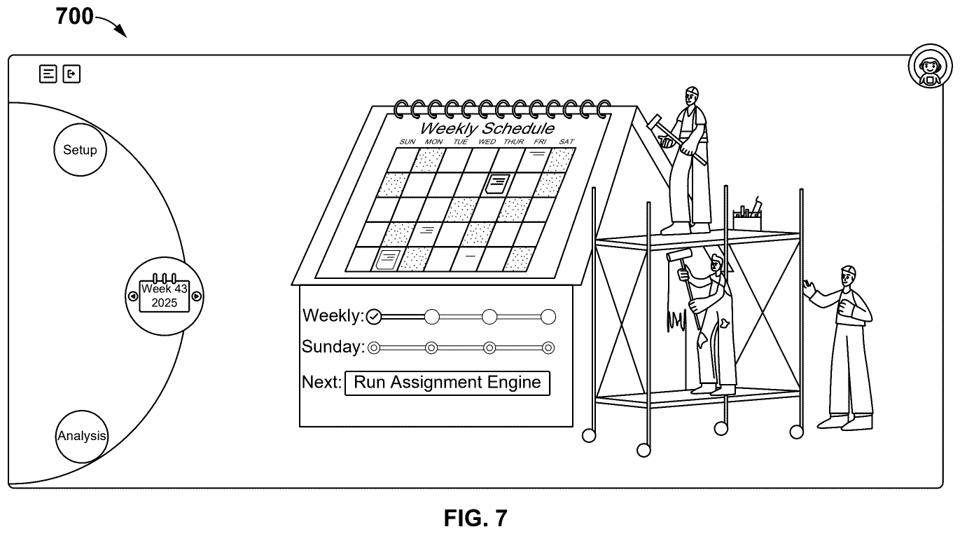

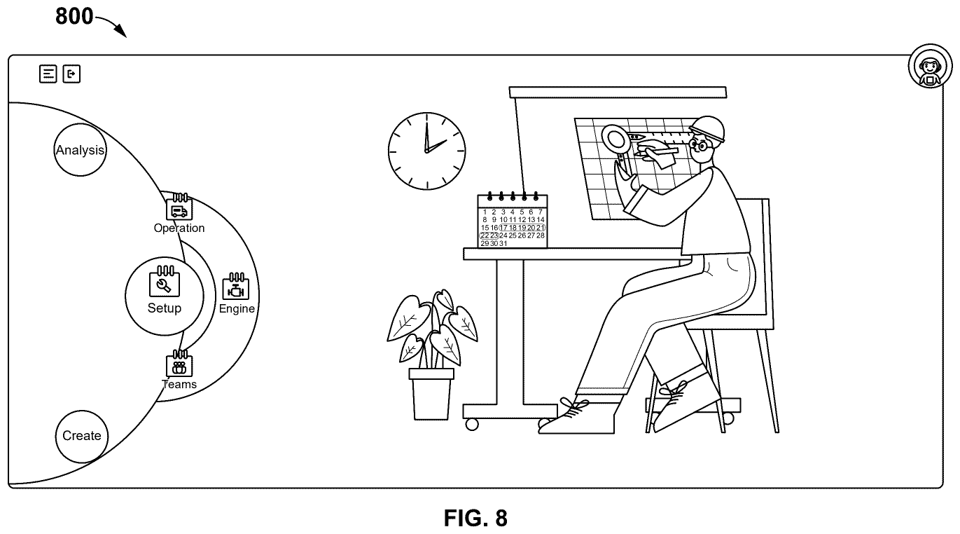

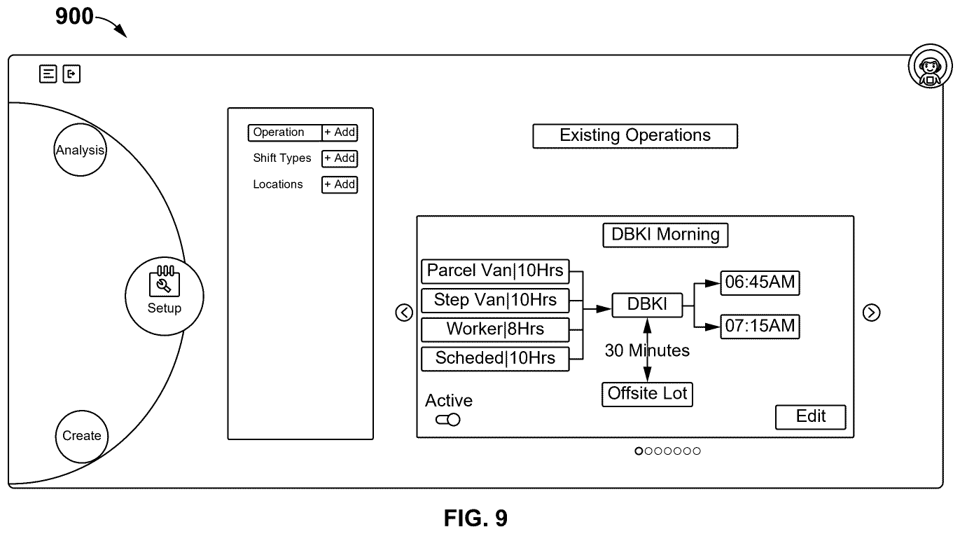

FIG. 7 illustrates a screenshot 700 of a user interface displaying the weekly schedule, one or more options to setup the weekly schedule and the chatbot, according to an embodiment of the present invention. The option comprises analysis, setup, and create. The user interface further comprises the chatbot configured to assist the user in resolving on-screen issues. FIG. 8 illustrates a screenshot 800 of the user interface displaying the setup option comprising operations, engine, and teams, according to an embodiment of the present invention. FIG. 9 illustrates a screenshot 900 of the user interface displaying an existing operation and one or more options configured to create a new operation including operation type, shift type based on qualification, and location, upon selecting the operation option, according to an embodiment of the present invention.

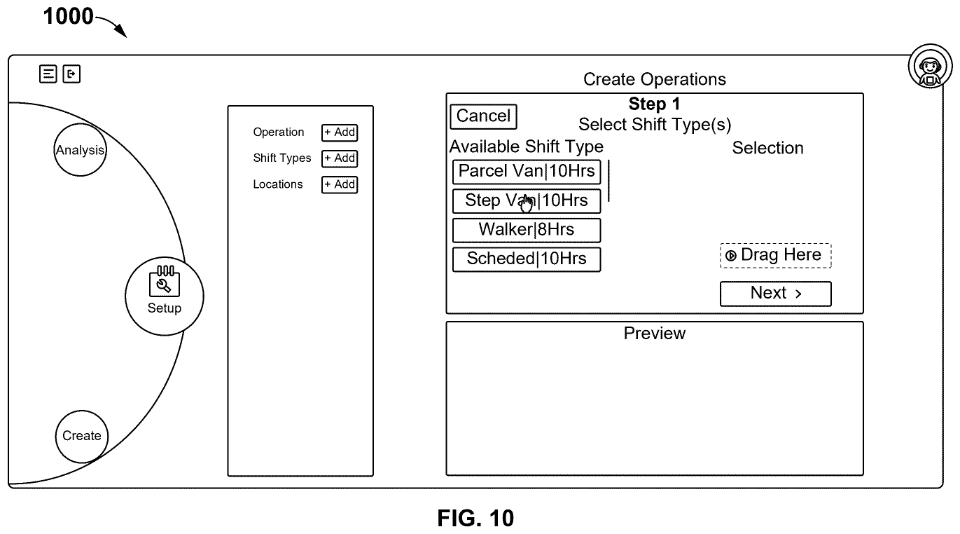

The operation type comprises a six steps process that is explained from FIG. 10 to FIG. 15. FIG. 10 illustrates a screenshot 1000 of the user interface enabling the selection of shift types to create the new operation, according to an embodiment of the present invention. The user interface is configured to display an available shift type section and a selection section. In one embodiment, the available shift type section includes, but not limited to, parcel van-10 hrs, step van-10 hrs, and walker-8 hrs. The system is configured to enable the scheduler to assign the shift type by dragging the desired shift type from the available shift type section and dropping the shift type into the selection section at a “drag here” area. The user interface further comprises a “Next” button and the chatbot. The chatbot is configured to assist the user and the “Next” button is configured to enable the scheduler to proceed to the next step.

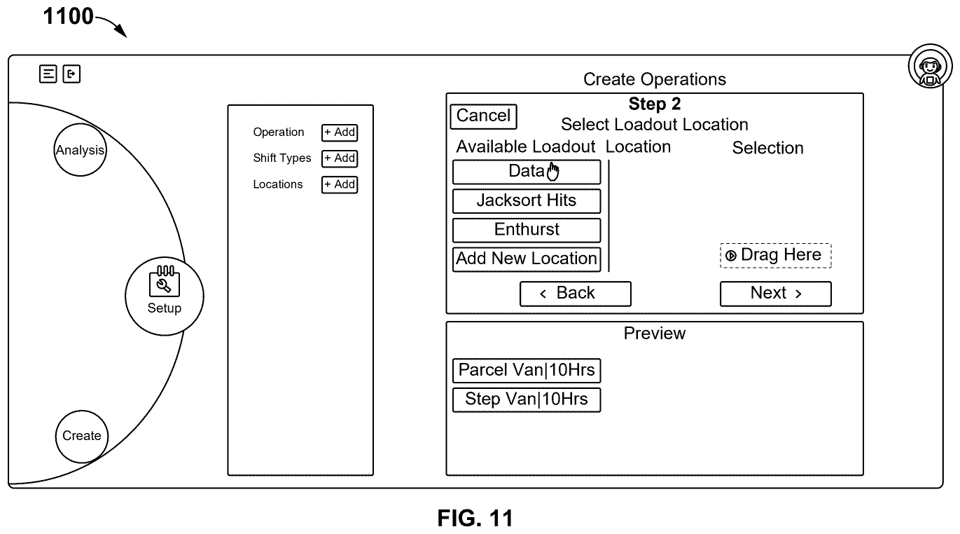

FIG. 11 illustrates a screenshot 1100 of the user interface enabling the selection of a loadout location for the new operation and providing the preview of selected shift type, according to an embodiment of the present invention. The user interface is configured to display an available loadout location section and a selection section. The user interface is configured to enable the scheduler to assign the loadout location by dragging the desired location from the available loadout location section and dropping the location into the selection section at a “drag here” area. The user interface is further configured to enable to add a new location under the available loadout location section if required. The user interface further comprises the “Next” button and the chatbot. The chatbot is configured to assist the user and the “Next” button is configured to enable the scheduler to proceed to the next step.

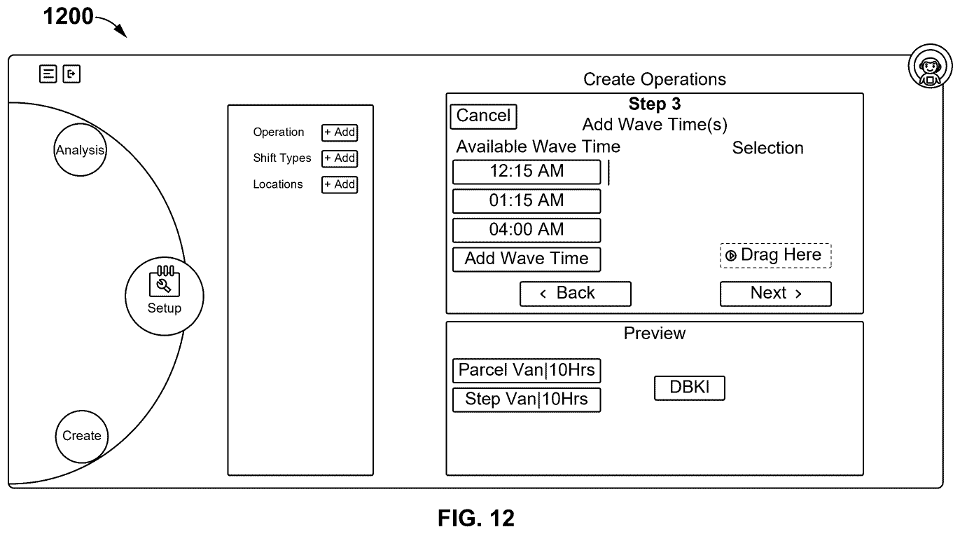

FIG. 12 illustrates a screenshot 1200 of the user interface enabling the selection of a wave time for delivering the load in the new operation and providing the preview of selected shift type and loadout location, according to an embodiment of the present invention. The user interface is configured to display an available wave time section and a selection section. The wave time is a time assigned to pick up the parcel. The user interface is configured to enable the scheduler to assign the wave time by dragging the desired wave time from the available wave time section and dropping the wave time into the selection section at a “drag here” area. The wave time includes, but not limited to, 12:15 am, 01:15 am, and 4:00 am. Further, the user interface is configured to enable to add new wave time under the “available wave time” section if needed. The user interface further comprises the “Next” button and the chatbot. The chatbot is configured to assist the user and the “Next” button is configured to enable the scheduler to proceed to the next step.

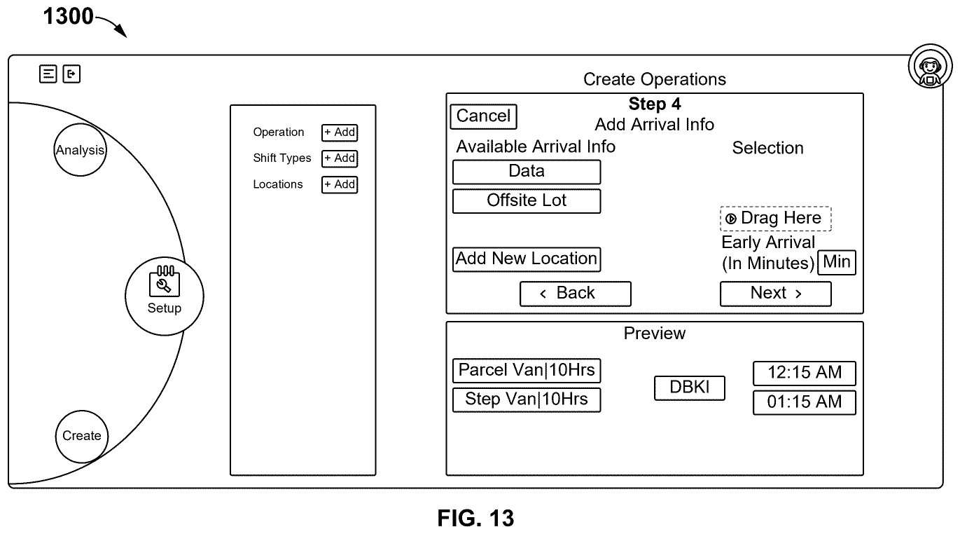

FIG. 13 illustrates a screenshot 1300 of the user interface enabling the selection of an arrival information for the new operation and providing the preview of selected shift type, loadout location, and wave time, according to an embodiment of the present invention. The user interface is configured to display an available arrival information section and a selection section. The user interface is configured to enable the scheduler to assign the arrival information by dragging the desired arrival information from the available arrival information section and dropping it into the selection section at a “drag here” area. The user interface is further configured to add new location under the “available arrival info” if required. The user interface further comprises the “Next” button and the chatbot. The chatbot is configured to assist the user and the “Next” button is configured to enable the scheduler to proceed to the next step.

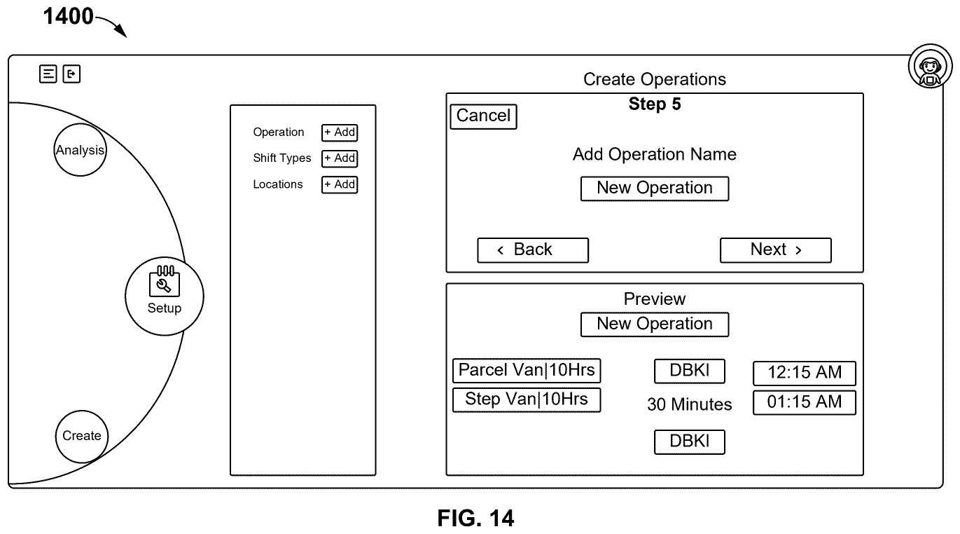

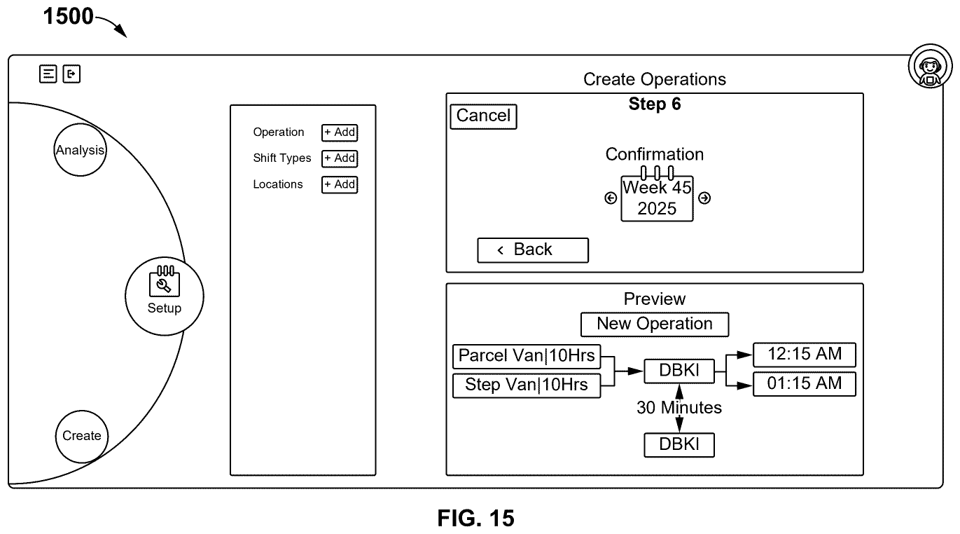

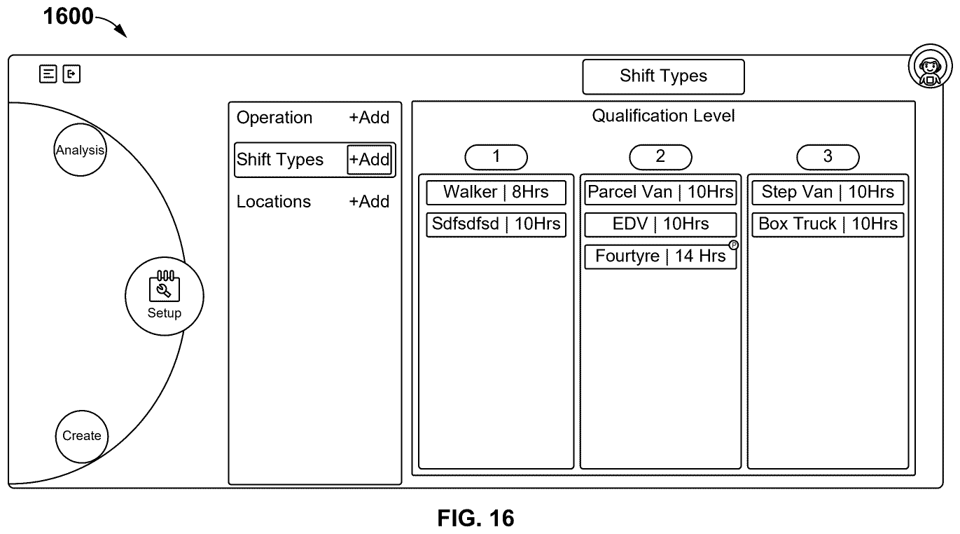

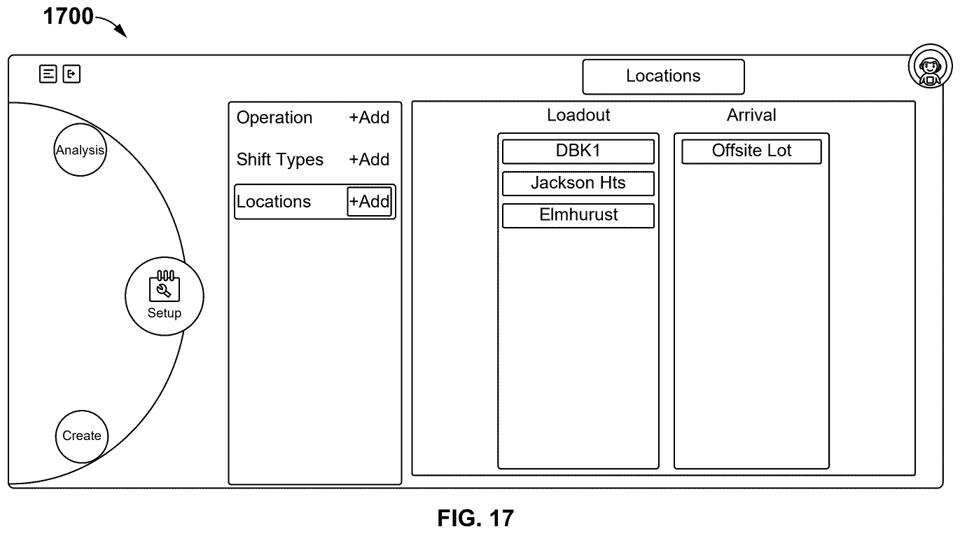

FIG. 14 illustrates a screenshot 1400 of the user interface enabling to add a name for the new operation and the preview selected shift type, loadout location, wave time, and arrival information, according to an embodiment of the present invention. The user interface further comprises the “Next” button and the chatbot. The chatbot is configured to assist the user and the “Next” button is configured to enable the scheduler to proceed to the next step. FIG. 15 illustrates a screenshot 1500 of the user interface confirming the creation of the new operation by submitting the operation details and preview of the created new operation, according to an embodiment of the present invention. Further, the user interface is configured to enable to assign new operation to the required week. FIG. 16 illustrates a screenshot 1600 of the user interface selection of shift type based on qualification for the new operation, according to an embodiment of the present invention. FIG. 17 illustrates a screenshot 1700 of the user interface selection of the location based on loadout and arrival of the new operation, according to an embodiment of the present invention.

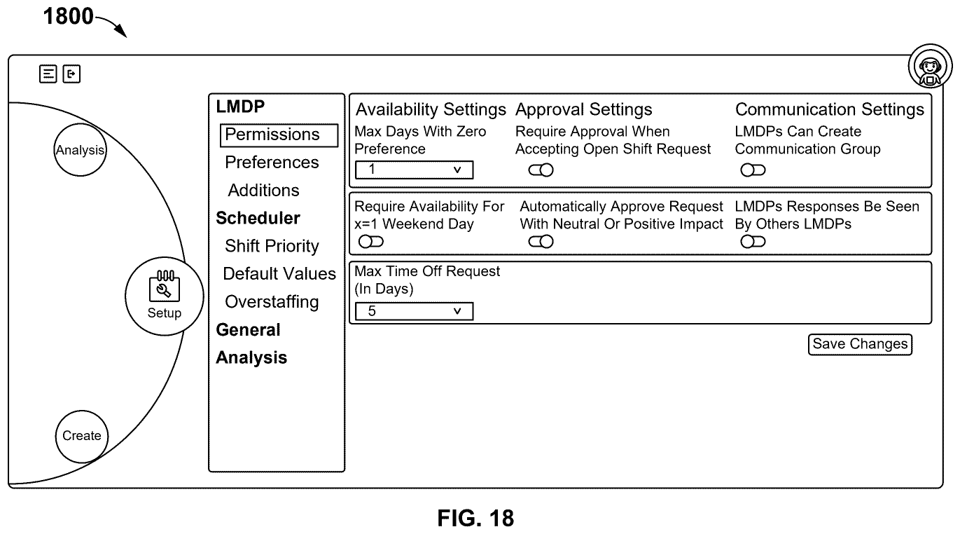

FIG. 18 illustrates a screenshot 1800 of the user interface displaying one or more permissions of the Last Mile Delivery partner (LMDP), according to an embodiment of the present invention. The user interface further displays the setting including availability settings, approval settings, and communication settings provided for the LMDP. The availability settings are configured to allow the scheduler to provide availability parameters for the LMDP. The parameters include, but not limited to, the maximum number of days with zero preference, weekend day availability requirements, and the maximum number of days allowed for time-off requests. The approval settings are configured to allow the scheduler to specify approval conditions for open shift requests and to enable automatic approval for requests with neutral or positive impact. The communication settings are configured to enable the scheduler to control communication permissions. The communication permissions include LMDPs could create communication groups and whether LMDP responses could be viewed by other LMDPs. The user interface further includes the chatbot and a “Save Changes” button. The chatbot is configured to assist the scheduler and the “Save Changes” button is configured to confirm and apply modifications to the scheduling process.

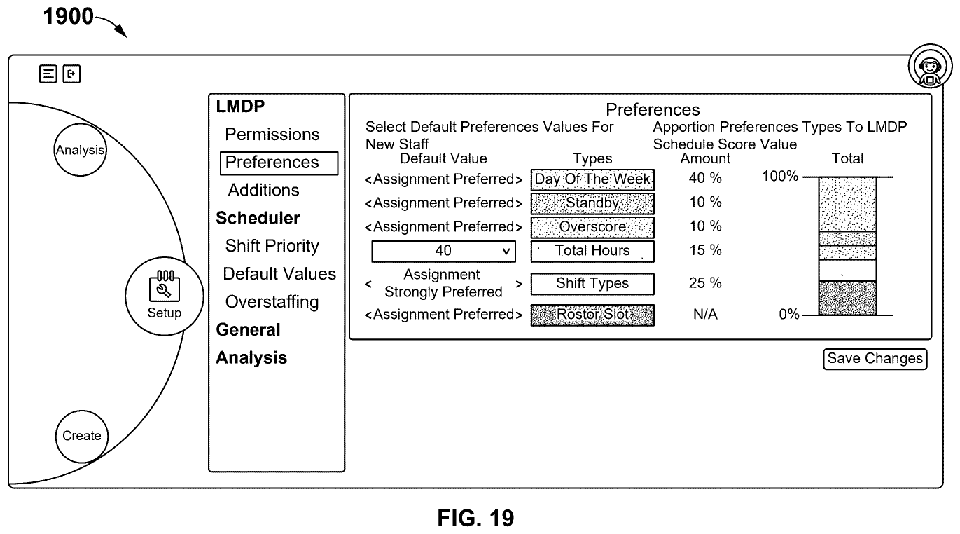

FIG. 19 illustrates a screenshot 1900 of the user interface displaying one or more settings related to the preferences for the LMDP, according to an embodiment of the present invention. The user interface is configured to enable the scheduler to set a default preferences for new employee or the staff. The default preferences include, but not limited to, preferred days of the week for assignment, preferred standby assignments, preferred overtime assignments, preferred total working hours, preferred shift types, and preferred roster slots. The user interface is configured to enable the scheduler to apportion preference types to LMDP schedule score values. The apportionment comprises 40 percent for preferred days of the week for assignment, 10 percent for preferred standby assignments, 10 percent for preferred overtime assignments, 15 percent for preferred total working hours, and 25 percent for preferred shift types. The user interface further includes the chatbot and the “Save Changes” button. The chatbot is configured to assist the scheduler and the “Save Changes” button is configured to confirm and apply modifications to the scheduling process.

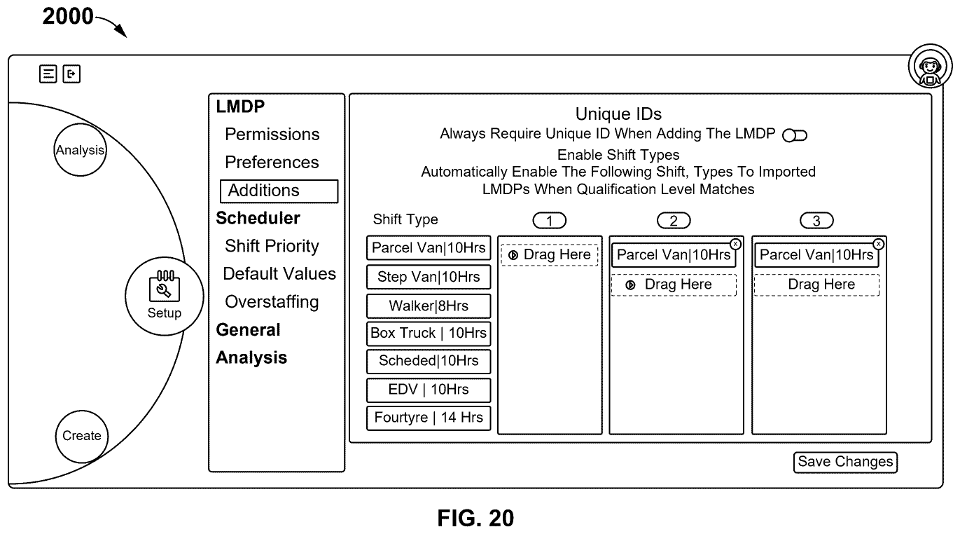

FIG. 20 illustrates a screenshot 2000 of the user interface displaying one or more settings related to the addition setting provided for the LMDP, according to an embodiment of the present invention. The user interface is configured to displaying the additional setting enables to automatically assign shift type when the qualification level of the employee is matched. In one embodiment, at least one qualification level is associated with at least one shift type. Once the shift type is allocated to a particular qualification level, the same shift type is prevented from being allocated to any other qualification level. Further, the addition of new employee requires a unique identification (ID) provided to the employee. The user interface further includes the chatbot and the “Save Changes” button. The chatbot is configured to assist the scheduler and the “Save Changes” button is configured to confirm and apply modifications to the scheduling process.

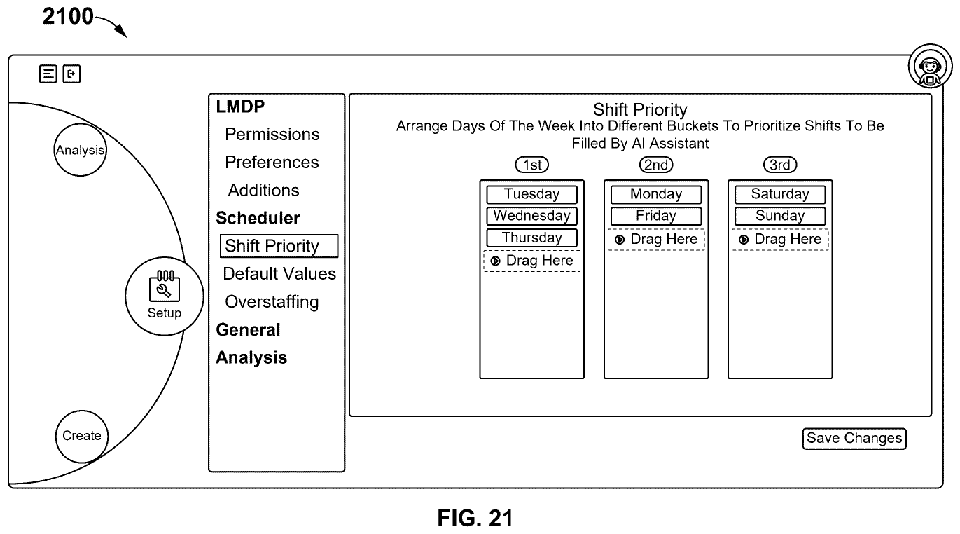

FIG. 21 illustrates a screenshot 2100 of the user interface displaying one or more settings related to the shift priority provided by the scheduler, according to an embodiment of the present invention. The user interface is configured to arrange days of the week into different buckets to prioritize the allocation of shifts to be automatically filled by the AI assistant. The days include Monday, Tuesday, Wednesday, Thursday, Friday, Saturday, and Sunday. Further, the user interface is configured to automatically assign shifts to the employee based on the provided shift priority via the AI assistant. The user interface further includes the chatbot and the “Save Changes” button. The chatbot is configured to assist the scheduler and the “Save Changes” button is configured to confirm and apply modifications to the scheduling process.

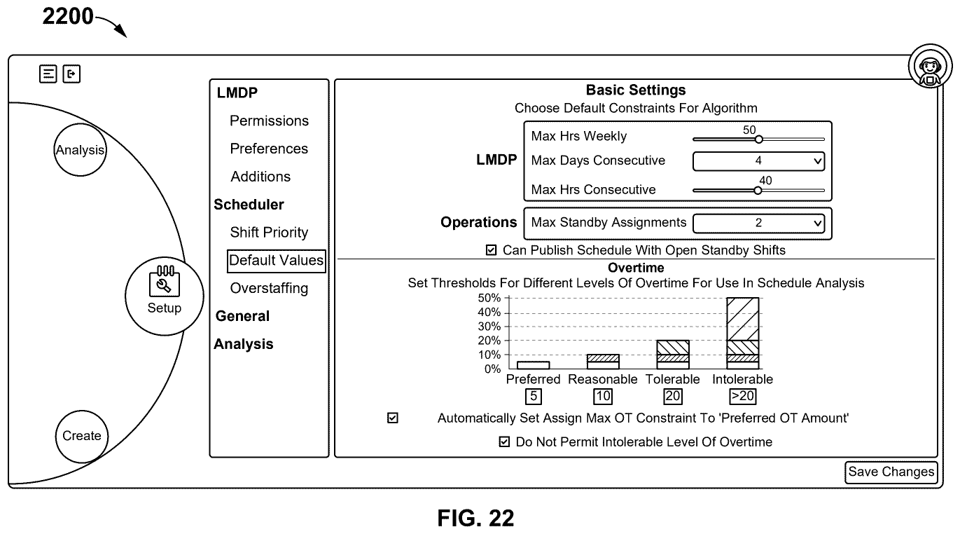

FIG. 22 illustrates a screenshot 2200 of the user interface displaying one or more settings related to the default values provided by the scheduler, according to an embodiment of the present invention. The user interface is configured to display a basic setting and a predefined threshold of overtime for scheduling analysis. The basic setting comprises a default constrains or parameter for the LMDP and the operations. The default parameter for the LMDP includes maximum hours weekly, maximum consecutive days, and maximum consecutive hours. For example, the maximum weekly hours are set to 50, the maximum consecutive days are set to 4, and the maximum consecutive hours are set to 40. The user interface further includes the chatbot and the “Save Changes” button. The chatbot is configured to assist the scheduler and the “Save Changes” button is configured to confirm and apply modifications to the scheduling process. The default parameter of the operations includes maximum standby assignments. The maximum standby assignments are set to 2.

The user interface further comprises a checkbox option displaying “can publish schedule with open standby shifts”. The predefined threshold is set for different levels of overtime for use in schedule analysis. The predefined threshold is displayed in a bar chart dividing overtime percentages into four categories. The four categories include preferred OT, reasonable OT, tolerable OT, and intolerable OT. For example, the preferred OT is set to 5 hrs, the reasonable OT is set to 10 hrs, the tolerable OT is set to 15 hrs, and the intolerable OT is set to 20 hrs. The user interface further comprises one or more checkbox options. The checkbox option includes, “automatically set AI assistant to assign max of constrains to preferred OT amount” and “do not permit intolerable level of overtime (OT). The user interface further includes the chatbot and the “Save Changes” button. The chatbot is configured to assist the scheduler and the “Save Changes” button is configured to confirm and apply modifications to the scheduling process.

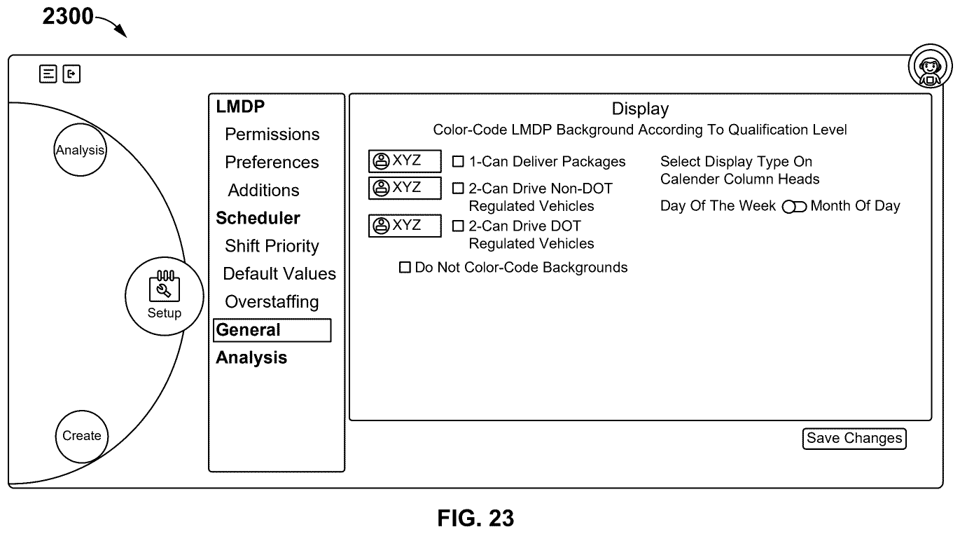

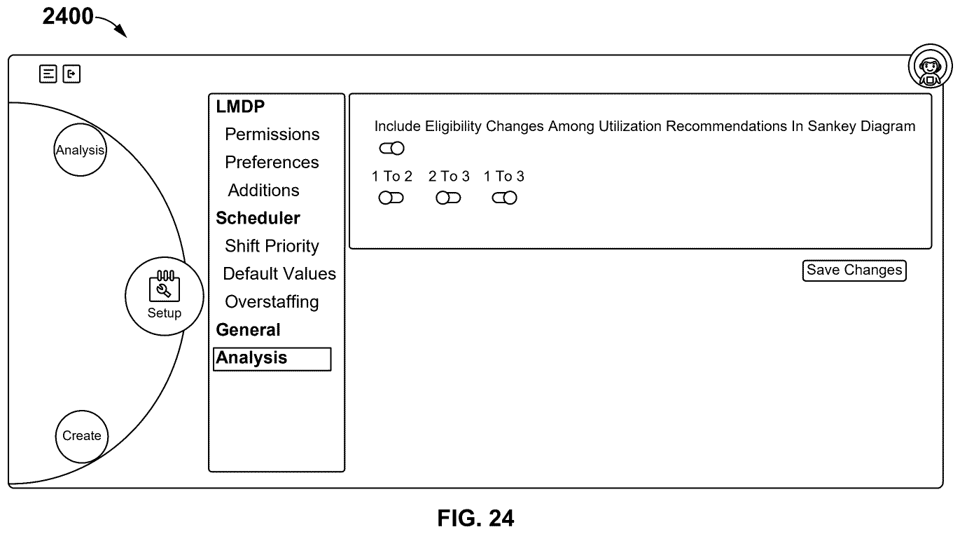

FIG. 23 illustrates a screenshot 2300 of the user interface displaying one or more general settings, according to an embodiment of the present invention. the general setting is configured to display the employee based on the qualification using one or more color indicator. At least one color indicates that the employee assigned can deliver the packages, at least one color indicates that the employee assigned can drive non-department of transportation (DOT) regulated vehicles, and at least one color indicates that the employee assigned can drive DOT regulated vehicles. DOT-regulated vehicles are vehicles that fall under the regulations of the U.S. Department of Transportation (DOT), whereas non-DOT-regulated vehicles do not meet the DOT's commercial thresholds. The user interface comprises a checkbox option and a calendar. The checkbox option includes “do not color code backgrounds”. The calendar is configured to select the display type on calendar column heads including day of the week and month and day. FIG. 24 illustrates a screenshot 2400 of the user interface displaying one or more analysis settings, according to an embodiment of the present invention. The user interface is configured to display an option labeled “include eligibility changes among utilization recommendations in the Sankey diagram”. The user interface is configured to enable the scheduler to recommend the employee who are capable for a particular shift type.

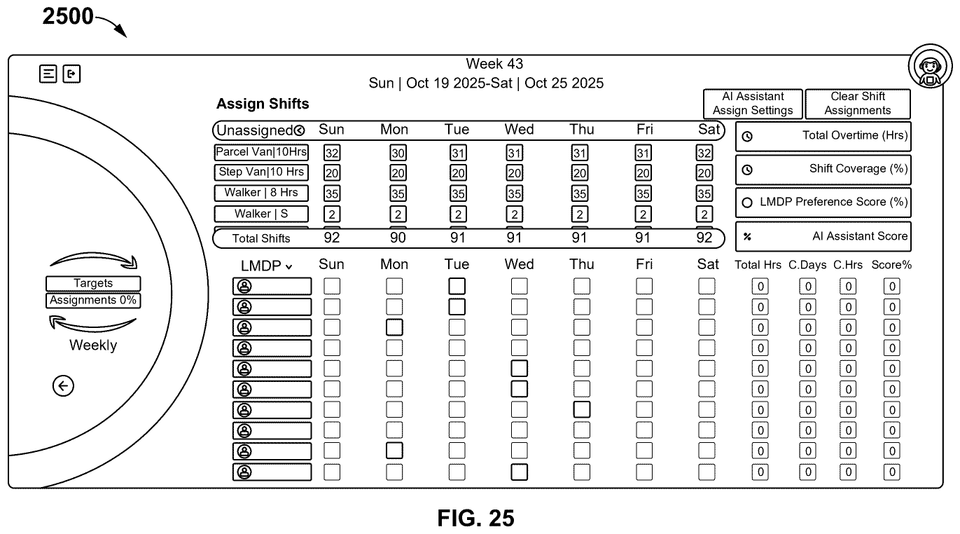

FIG. 25 illustrates a screenshot 2500 of the user interface displaying unassigned shifts of a 43rd week, according to an embodiment of the present invention. The user interface comprises one or more options. At least one option comprises a target configured to assign and update the targets for the week. The user interface is configured to display the unassigned shifts that reflecting the targets assigned for each day of the week. The unassigned shifts comprise the unassigned total shift for each day. For example, the unassigned total shift of the Sunday is 92, the total shift of the Monday is 90, the total shift of the Tuesday, Wednesday, Thursday, Friday is 91, and the total shift of the Saturday is 92. The option further comprises a “AI assistant assign settings” and “clear shift assignment”. The user interface is further configured to enable the scheduler to manually or automatically assign shifts to each employee. The manual assignment process includes selecting each day and assigning the available employee to the corresponding shift. The automatically assignment process includes selecting the AI assistant assign settings to automatically assign shifts for the employee. The user interface is configured to display the total overtime, shift coverage, LMDP preference score, and AI assistant score following the assignment of shift types to employees.

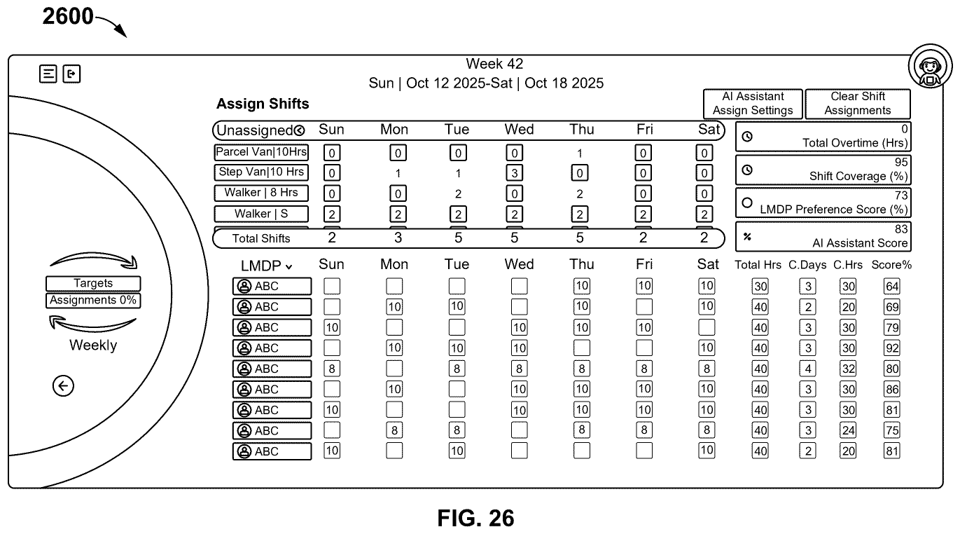

FIG. 26 illustrates a screenshot 2600 of the user interface displaying unassigned shifts and assigned shifts of a 42nd week, according to an embodiment of the present invention. The user interface is configured to enable the scheduler to assign the shifts for the unassigned total shift. For example, the unassigned total shift of the Sunday is 2, the total shift of the Monday is 3, the total shift of the Tuesday, Wednesday, Thursday, is 5, the total shift of Friday is 2 and the total shift of the Saturday is 2. Further, the user interface is configured to display the assigned employees along with the corresponding shifts assigned to each employee. The user interface is configured to display the total overtime is 0 percent, shift coverage is 95 percent, LMDP preference score is 73 percentage, and AI assistant is 83 percentage following the assignment of shift types to employees.

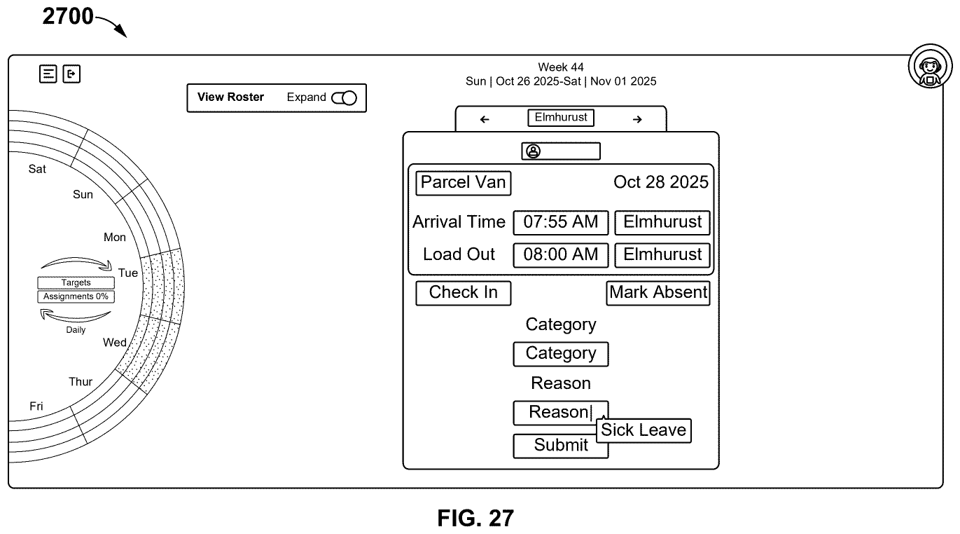

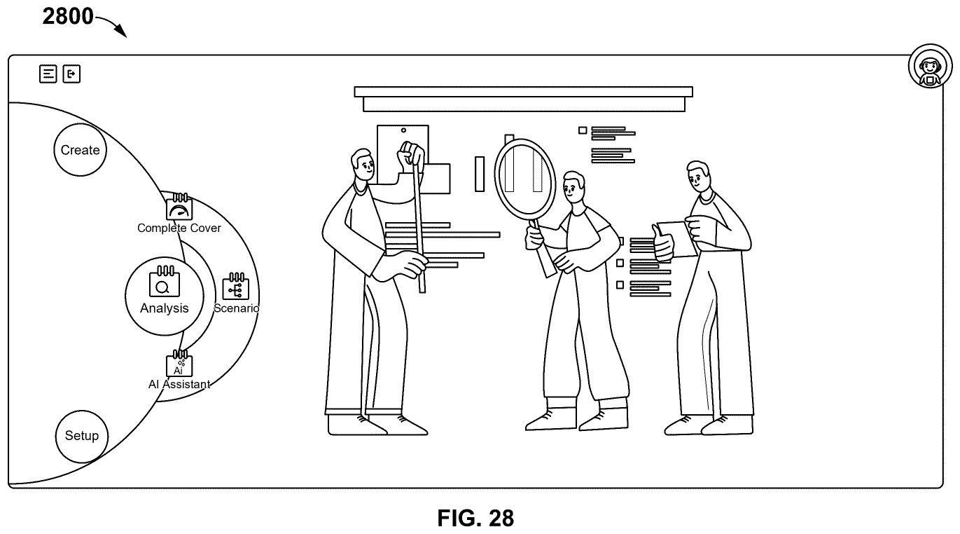

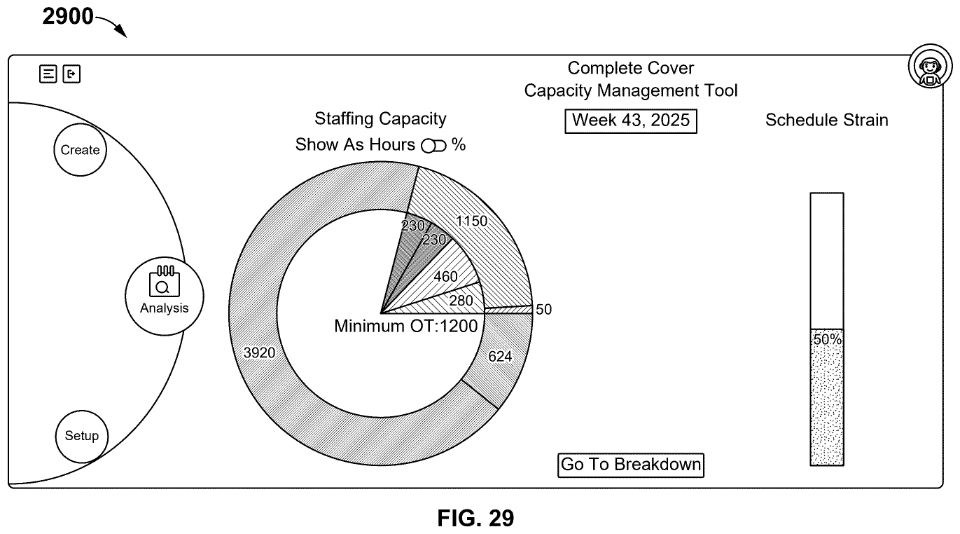

FIG. 27 illustrates a screenshot 2700 of the user interface displaying a daily roster, according to an embodiment of the present invention. The daily roster is configured to enable the scheduler to assign shifts for any unassigned days and shifts. The daily roster is configured to ensure that each day includes at least one assigned shift. Further, the user interface is configured to record the employee absences on unavailable days and submit the provided reason. FIG. 28 illustrates a screenshot 2800 of the user interface displaying analysis option including the complete cover, the scenario, and the artificial intelligence (AI) assistant, according to an embodiment of the present invention. FIG. 29 illustrates a screenshot 2900 of the user interface displaying the complete cover of the 43rd week, according to an embodiment of the present invention. The complete cover is configured to display the graph indicating that maximum hour cover is 3920 hrs, minimum OT hours include understaffed 1150 hrs, unutilized hours is 50 hrs, and overstaffed is 624 hrs. Further, the minimum OT includes preferred OT of 230 hrs, reasonable OT of 230 hrs, tolerable OT of 460 hrs, and intolerable OT of 280 hrs.

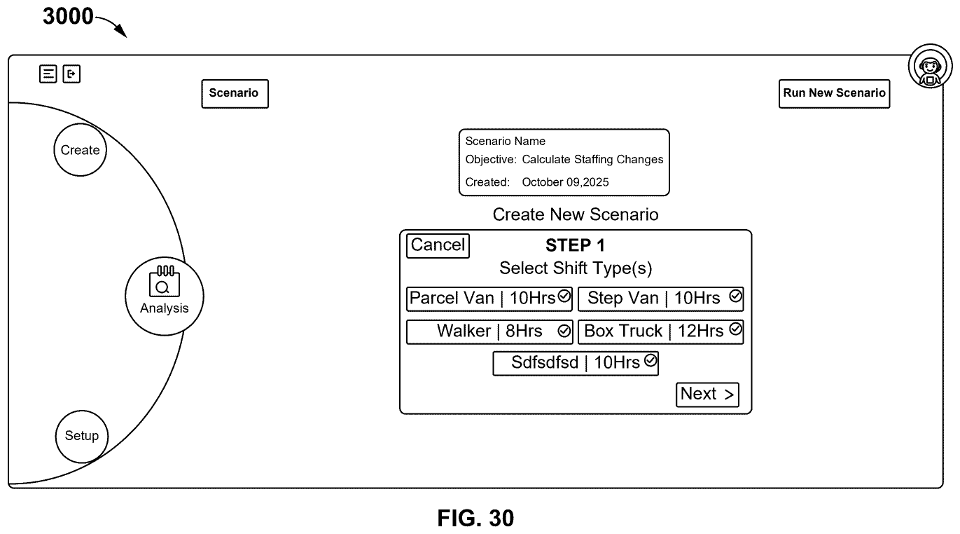

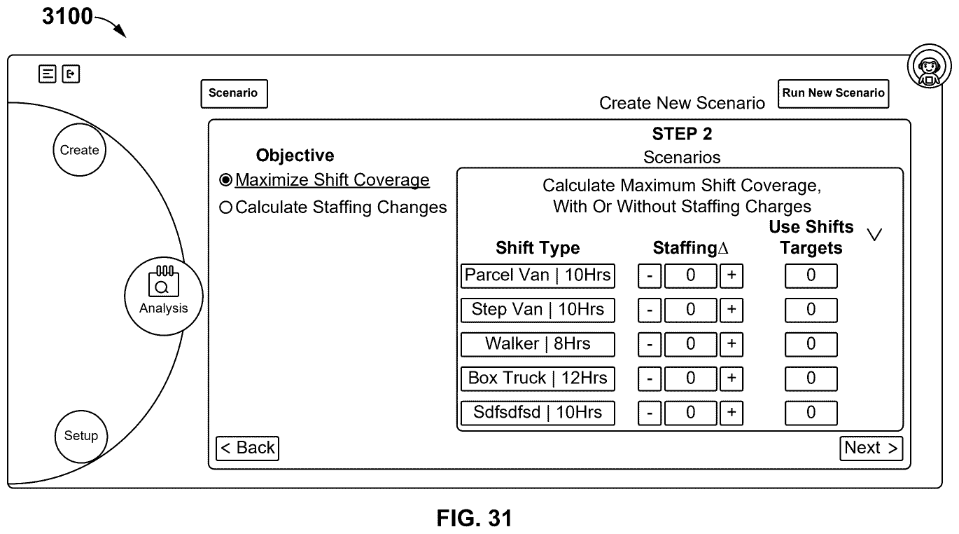

The scenario comprises six step process that is explained from FIG. 30 to FIG. 36. FIG. 30 illustrates a screenshot 3000 of the user interface enabling selection of the shift type to create a new scenario, according to an embodiment of the present invention. The user interface is further configured to enable the scheduler to add new scenario by clicking “run new scenario”. Further, the user interface is configured to enable the scheduler to add shift type. The shift type includes but not limited to, parcel van-10 hrs, step van-10 hrs, walker-10 hrs, and box truck-12 hrs. The user interface further comprises the “Next” button and the chatbot. The chatbot is configured to assist the user and the “Next” button is configured to enable the scheduler to proceed to the next step. FIG. 31 illustrates a screenshot 3100 of the user interface enabling to calculate the maximum shift coverage for the new scenario, according to an embodiment of the present invention. The user interface is configured to enable the scheduler to add staffs and shift targets based on the required operation and enable to calculate the maximum shift coverage. The user interface further comprises the “Next” button and the chatbot. The chatbot is configured to assist the user and to the “Next” button is configured to enable the scheduler to proceed to the next step.

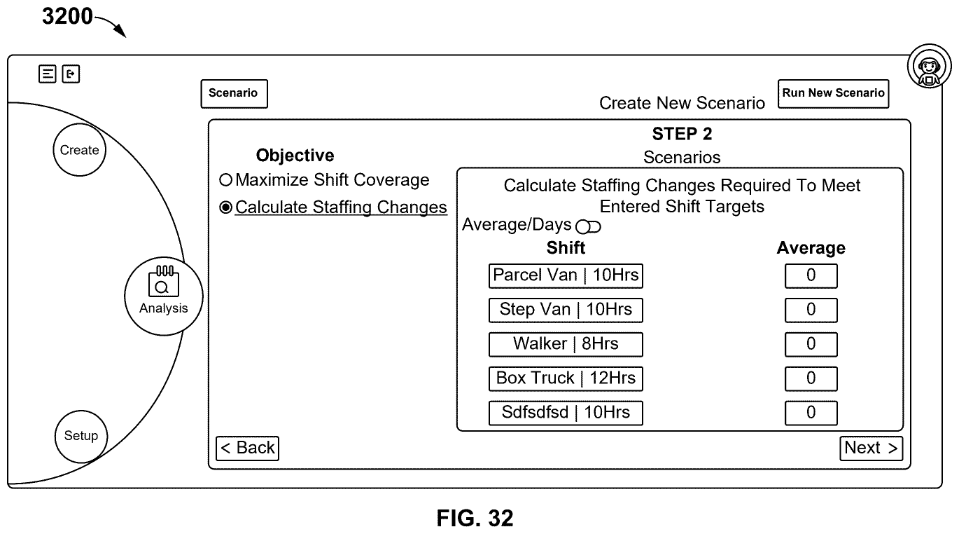

FIG. 32 illustrates a screenshot 3200 of the user interface enabling to calculate the staffing changes for the new scenario, according to an embodiment of the present invention. The user interface is configured to add the shift type based on the required operation and calculate the staffing changes. The user interface further comprises the “Next” button and the chatbot. The chatbot is configured to assist the user and the “Next” button is configured to enable the scheduler to proceed to the next step.

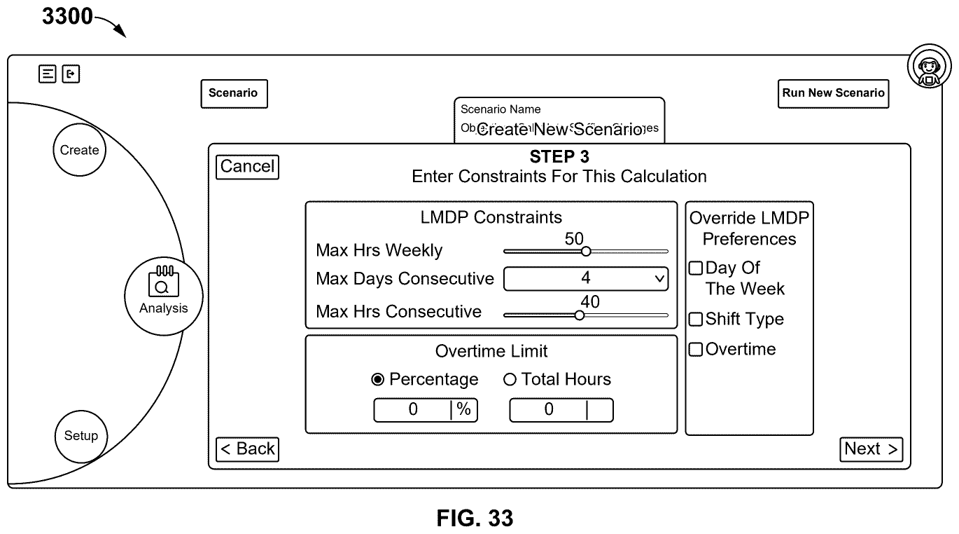

FIG. 33 illustrates a screenshot 3300 of the user interface enabling selection of the LMDP constrains and the override LMDP preferences for the new scenario, according to an embodiment of the present invention. The LMDP constrain includes maximum hours weekly, maximum consecutive days, and maximum consecutive hours. For example, the maximum weekly hours are set to 40, the maximum consecutive days are set to 4, and the maximum consecutive hours are set to 40. The override LMDP preferences include day of the week, shift type, and overtime. The user interface is configured to enable to set the overtime limit. The overtime limits are provided in terms of percentage and total hours. The user interface further comprises the “Next” button and the chatbot. The chatbot is configured to assist the user and the “Next” button is configured to enable the scheduler to proceed to the next step.

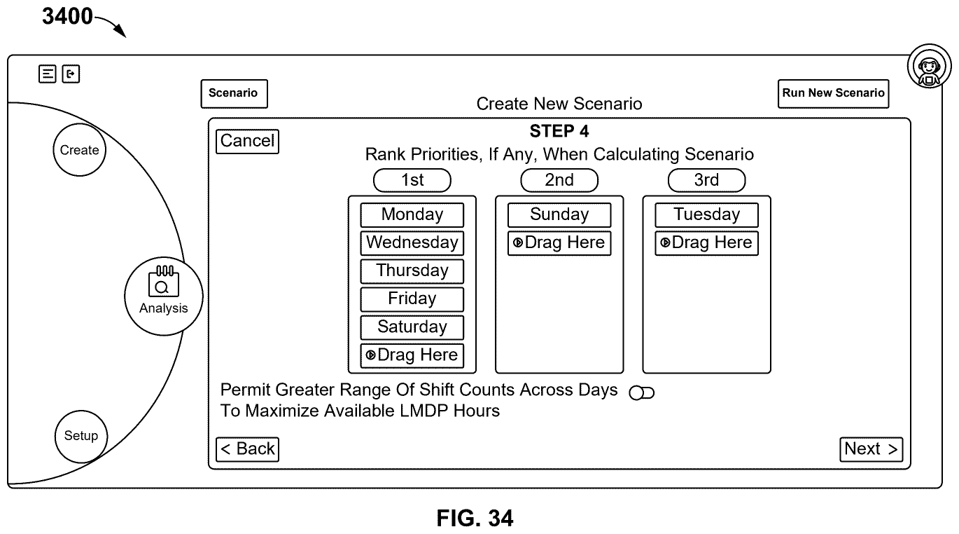

FIG. 34 illustrates a screenshot 3400 of the user interface selecting the priority of the week for the new scenario, according to an embodiment of the present invention. The user interface is configured to rank the priorities, if any, when calculating scenario. For example, a 1^{st} priority is the shifts of Monday, Wednesday, Thursday, Friday, and Saturday, a 2^{nd} priority is the shifts of Sunday, a 3^{rd} priority is the shifts of Tuesday. The user interface further comprises at least one option configured to permit greater range of the shift counts across days to maximize available LMDP hours. The user interface further comprises the “Next” button and the chatbot. The chatbot is configured to assist the user and the “Next” button is configured to enable the scheduler to proceed to the next step.

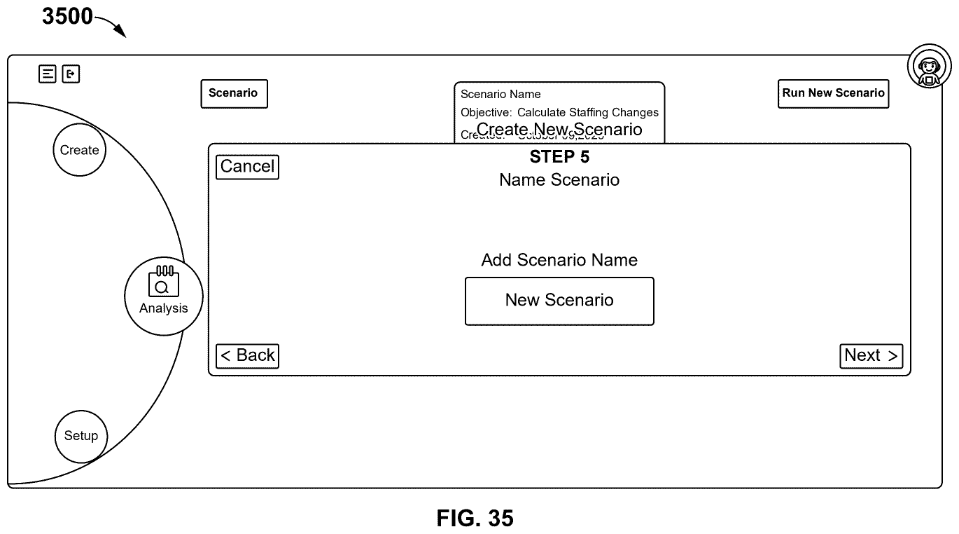

FIG. 35 illustrates a screenshot 3500 of the user interface enabling to add a name for the new scenario, according to an embodiment of the present invention. The user interface further comprises a “Calculate Output” button configured to calculate the output of the newly added scenario once the name is provided. The user interface further comprises the chatbot configured to assist the user.

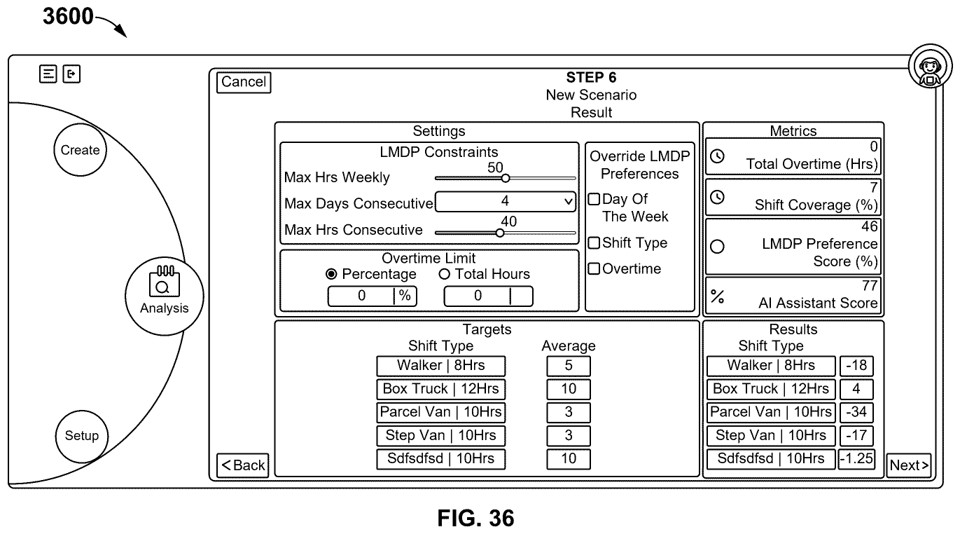

FIG. 36 illustrates a screenshot 3600 of the user interface providing the result of the new scenario, according to an embodiment of the present invention. The user interface is configured to display the parameters set to the scenario, including settings, targets, metrics, and results. The metrics are configured to display calculated parameters including total overtime hours, average hours per LMDP, LMDP preference score, and AI assistant. For example, total overtime hours are 0%, average hours per LMDP is 7%, LMDP preference score is 46%, and the AI assistant score is 77%. The targets section provides a summary of the average shift type targets and the results section displays the corresponding outcomes for each shift type. The user interface further comprises a “Re-Run” button and the “Save” button. The “Re-Run” button is configured to allow the scheduler to re-execute the scenario calculation. The “Save” button is configured to save the generated results and incorporate them into upcoming shifts. The user interface further comprises the chatbot configured to assist the user.

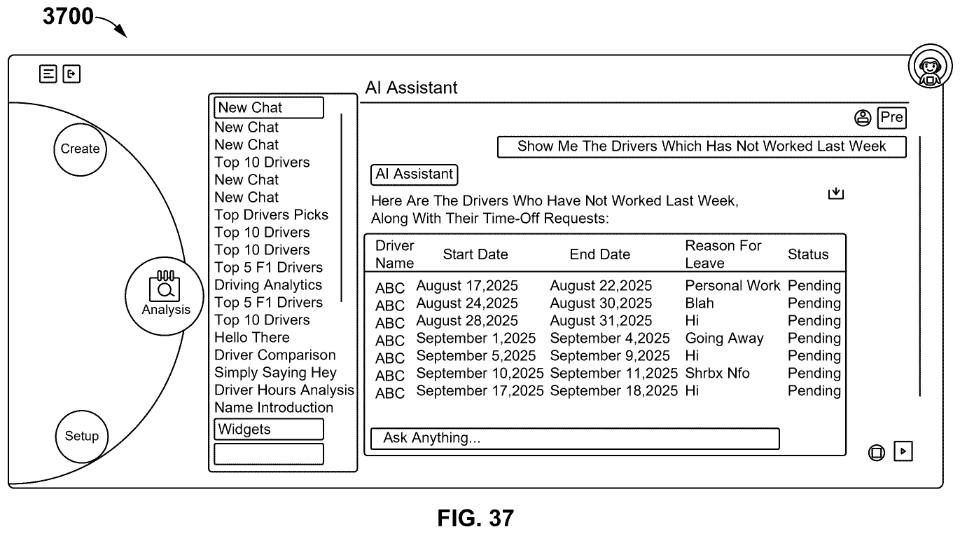

FIG. 37 illustrates a screenshot 3700 of the user interface displaying at least one query submitted to the artificial intelligence (AI) assistant, according to an embodiment of the present invention. The query includes “show me the drivers who has not worked last week” is submitted to the AI assistant. The AI assistant is configured to provide a list of drivers or employee who have not worked in the previous week along with the time-off requests details. The time-off requests details include start and end dates, reason for leave, and status of each request.

Advantageously, the system is configured to enable automated and streamline shift scheduling process that reduces the manual scheduling and minimizes errors. The automated scheduling improves operational efficiency and ensures schedules are created more accurately and quickly.-Further, the system is configured to analyze and adjust the shift based on the employee preferences and targets to be completed. Further, the system is configured to ensure a reduction in last-minute schedule changes, dropouts, late arrivals, and missing out the assigned shifts. Further, the system is configured to provide the numeric feedback in terms of score to each employee schedule every week based on the work performance.

Further, the system is configured to predict the number of drivers or the employee required in future for overtime and shifts based on historical and real-time data. Further, the system is configured to incorporates precision, consistency, and impartiality and provides constant reminders of managerial legitimacy. Additionally, the system is configured to improve the scheduling, shift management, and component processes through automation and real-time communication. Further, the system is configured to segregate the assignment of shift type and day from the rostering process which is necessary condition in the last-mile logistics industry. Further, the segregation provides a clearer visibility into assignments before allocating the time and locations. Further, the system includes one or more ascribing weights which is from zero signifying prohibition to third signifying mandatory assignment, to this particular set of variables is unique. The set of variables includes distribution time and location preferences, shift type preference, and day of the week preference. In addition, the system automatically refreshes all scheduling-related visualizations whenever a key scheduling trigger changes. Triggers include shift targets; scheduling preferences such as weekly or daily hour limits, overtime eligibility, or standby inclusion; individual shift type enablement; employee qualifications and eligibility; and employee status changes. When any trigger is modified, the system invalidates existing visualization states and regenerates affected dashboards automatically, ensuring users never rely on stale data.

Furthermore, the system is configured to generate and publish a schedule containing day and shift type data early in the week. This is done to comply with Department of Labor regulations, which restrict last-minute scheduling. To meet these requirements, the scheduling process is designed to be separable, allowing adjustments to be made without violating legal constraints. Further, consideration to other variables is unique, when prioritizing the coverage of certain days such as weekends, over others to maximize target coverage. Further, the system considers the previous and current week consecutive days and hours for assigning shifts to employee helps to avoid running afoul of labor laws. Further, the system is configured to create minimum hours figure as a relative constraint on imbalanced schedule between employees. The system provides robust incident reporting and enhanced analytics capabilities to highlight the extensibility of the platform.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” and/or “comprising”, when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for automated work shift management, comprising:
at least one user device associated with at least one user, wherein the users comprise one or more schedulers, employees, and administrators;
at least one database configured to store an operational requirement data received from the scheduler, an employee preference data received from the employee, a performance history data of the employee, a physical asset data including information related to physical assets, and a schedule data, and
at least one computing device in communication with the user device and the database via a network, wherein the computing device comprises at least one memory configured to store a set of program modules and at least one processor configured to execute one or more program modules, wherein the program modules comprise:
an input module configured to receive the operational requirement data and the employee preference data via the user device, wherein the operational requirement data, including a schedule data and physical asset data;
a roster module configured to assign at least one weekly schedule and corresponding physical assets for each employee based on at least one of the employee preference data, the equipment care score aligned with the operational requirement data, and the performance history, wherein the weekly schedules include a daily shift and one or more upcoming shifts with corresponding tasks;
a roster management module configured to organize the daily shift, enable the scheduler to modify and finalize the daily shift based on last-minute updates received from the employee, and publish the finalized daily shift schedule and task to the employee;
an analytic module configured to analyze the performance of the employee to generate a performance score and assess the condition of physical assets to update the equipment care score, and
a summary generating module configured to generate one or more weekly summaries and performance reports based on the performance score and equipment care score.

2. The system of claim 1, wherein the operational requirement data includes shift types, shift timings, distribution times, required qualifications for each shift, locations, capacity limits per location, scheduling settings, feedback metrics, aggregate shift coverage by type and day, individual employee schedules, manual assignments, weekly targets, and required employee availability.

3. The system of claim 1, wherein the employee preference data includes preferred days of the week, preferred shift types, preferred work locations, preferred working hours, availability data including leave and time-off requests, shift qualification levels, overtime consent, qualification updates, and any last-minute unavailability of the employees.

4. The system of claim 1, wherein the performance history of the employee comprises previous shift performance score, adherence to scheduled timings, overtime records, match confidence percentage, behavioral status, and equipment care scores derived from historical behavioral data of each employee with corresponding physical asset.

5. The system of claim 1, wherein the roster management module is configured to generate shift schedules by balancing one or more parameters to produce optimized and equitable scheduling outcomes, wherein the outcomes include encouraging temporal consistency with the previous week's shifts, reducing overtime penalties, and rewarding familiarity by providing bonuses for frequently assigned locations, wherein the parameters include minimizing unfilled shifts and over-assigned hours, maximizing driver satisfaction with respect to both preferred days and shifts, and giving priority to preferred locations during the rostering process, wherein the roster module is configured to generate the weekly schedule based on partial input data comprising at least one of operational requirement data and employee preference data and publish the weekly schedule prior to a predefined number of days before a corresponding shift date.

6. The system of claim 1, wherein the analytic module is configured to:
manage coaching workflow and rewards, and evaluates key performance indicators (KPIs) including delivery accuracy, adherence to safety protocols, and teamwork, and
receive one or more scenario setups and enable evaluate the effect of incorporating changes into upcoming shifts and tasks, to determine whether the changes produce improved scheduling results, wherein the changes include the changes made to the operational requirement data, shift type, employee, and location.

7. The system of claim 1, wherein the analytic module is configured to provide real-time insights into shift coverage efficiency and staffing optimization, including daily shift coverage, overstaffed and understaffed shifts, workforce locations, employees available for overtime (OT), imbalanced qualification distributions, and missed opportunities resulting from restrictive day or shift preferences, and wherein the analytic module further classifies employees in the understaffed shifts according to overtime preferences, including preferred overtime, reasonable overtime, tolerable overtime, and intolerable overtime.

8. The system of claim 1, further comprises one or more artificial intelligence (AI) assistances, wherein the AI assistant is configured to provide answers for one or more workforce-related queries, wherein the queries are related to employee attendance, shift coverage, performance metrics and summaries, and the frequently used queries are stored as reusable dashboard widgets for rapid access, wherein the answers are provided in one or more formats including spreadsheets, charts, graphs, and trendlines, wherein at least one AI assistance is implemented as a chatbot comprising a text-messaging interface and a voice interface, and is configured to receive user input and provide responses in at least one of voice and text formats, wherein the chatbot is configured to assist the user with on-screen issues by providing interactive guidance, troubleshooting steps, and contextual recommendations based on the current user interface.

9. The system of claim 1, wherein the analytic module is configured to:
evaluate leave, time-off records, and availability data of the employee to ensure no on days when the employee is unavailable or has indicated non-preference;
verify employee qualification to confirm eligibility for assigned shifts based on required certification or license type;
ensure each employee is assigned to shifts per day in compliance with labor and fatigue standards;
ensure each employee is assigned within predefined capacity parameters corresponding to the specific shift, location, and time;
detect manually assigned shifts and ensure manual assignments remain unaltered during automated optimization processes;
calculate total assigned working hours to enforce maximum limits defined by contractual and regulatory maximum working hour limits, and
verify overtime consent enforcement to avoid assigning shifts beyond standard working hours for employees who have not agreed to work overtime.

10. The system of claim 1, wherein the analytic module is configured to:
ensure combined overtime hours across all the employee do not exceed the global company-defined limit;
ensure the employees do not exceed the predefined number of consecutive working days and hours to prevent burnout and maintain compliance;
perform two-week continuity analysis to detect excessive continuous work cycles;
validate the integrity of shift, location and time mappings, excluding invalid configurations;
analyze and balance overall workload distribution to ensure fair allocation of total hours and shifts among all available employees,
enable automated computation of bonuses and penalty deductions based on predefined performance thresholds via a payroll system, and comprises coaching workflow context configured to maintain a note-based history and provides escalation triggers to initiate formal offboarding or remediation processes for underperforming employee,
enforce a set of predefined scheduling constraints stored in the database, wherein the predefined scheduling constraints are applied during at least one of weekly schedules, daily rostering, or re-optimization of schedules to ensure compliance with labor, contractual, and operational deployment policies.

11. The system of claim 1, further comprises a verification module configured to:
verify attendance of the employee at one or more depot entry points based on one or more attributes, including uniform compliance, identity recognition, and behavioral analysis via a camera;
record the identity recognition to match confidence level of the employee and flag a failed verification attempt, and
enable a supervisor to manually verify the employee following the failed verification, wherein the verification module is configured to record the action of the supervisor along with a timestamp.

12. The system of claim 10, wherein the verification module is configured to
enable the supervisors to validate asset condition at check-in and return points;
generate one or more incident tickets for lost or damaged assets, missed handovers, or incomplete routes, and
assign and transmit equipment care score to central operational dashboards.

13. The system of claim 1, further comprises:
a notification module configured to notify the employee regarding changes made to finalized schedules and tasks, generate one or more alerts to the scheduler regarding employee last-minute updates and compliance breaches, and maintain a complete history of all manual overrides performed on schedules;
a tracking module configured to track the status of physical assets assigned to the employees, wherein the status includes active, in repair, or suspended, wherein the tracking module maintains a log of issuance and return activities for the physical assets, and is further configured to automatically detect and flag any physical asset with a history of damage for initiating corrective actions or penalty enforcement, and
a forecasting module configured to automatically forecast the upcoming shifts and tasks based on weekly summaries and performance reports.

14. The system of claim 13, wherein the forecasting module configured to:
evaluate the alignment between workforce availability and delivery objectives based on a visual and predictive staffing engine;
Identify overstaffing, understaffing, and skill mismatches by comparing actual staffing levels with target shift coverage;
optimize scheduling arrangements for maximum shift coverage and suggestions to reallocate shifts and relax scheduling constraints, and
generate staffing arrangement based on predefined variables, including overtime thresholds and preference override options.

15. The system of claim 1, is executed in a Software as a Service (SaaS)-based multi-tenant system configured to provide isolated data environments and customizable settings for each of a plurality of companies, wherein the SaaS system comprises a role-based access control (RBAC). the RBAC being configured to enable the scheduler to create at least one template for operational requirements, the employee to provide employee preferences, and the administrators to manage subscriptions and handle employee roles and permissions and to manage operations and employee engagement.

16. A method for automated work shift management, comprising steps of:
receiving, at the computing device via an input module, the operational requirement data, and the employee preference data via the user device, wherein the operational requirement data, including the schedule data and physical asset data;
assigning, at the computing device via a roster module, at least one weekly schedule and corresponding physical assets for each employee manually based on at least one of the employee preference data and equipment care score aligned with the operational requirement data, and the performance history, wherein the weekly schedules include a daily shift and one or more upcoming shifts with corresponding tasks;
organizing, at the computing device via a roster management module, the daily shift and enables the scheduler to modify and finalize the daily shift based on last-minute updates received from the employee;
publishing, at the computing device via the roster management module, the finalized daily shift schedule and task to the employee;
analyzing, at the computing device via an analytic module, the performance of the employee to update a performance score;
assessing, at the computing device via the analytic module, the condition of physical assets to update the equipment care score;
managing, at the computing device via the analytic module, coaching workflow, rewards, and evaluate key performance indicators (KPIs) including delivery accuracy, adherence to safety protocols, and teamwork, wherein the coaching workflow comprises a note-based history and provides escalation triggers to initiate formal offboarding or remediation processes for underperforming employee, and
generating, at the computing device via a summary generating module, one or more weekly summaries and performance reports based on the performance score and equipment care score.

17. The method of claim 16, further comprises a step of forecasting the scheduling process, which involves:
automate forecasting of the upcoming shifts and tasks using weekly summaries and performance reports;
evaluating the alignment between workforce availability and delivery objectives based on the visual and predictive staffing engine;
identifying, at the computing device via the forecasting module, overstaffing, understaffing, and skill mismatches by comparing actual staffing levels with target shift coverage;
optimizing, at the computing device via the forecasting module, the scheduling arrangements for maximum shift coverage and
suggestions to reallocate shifts and relax scheduling constraints, and generating, at the computing device via the forecasting module, staffing arrangement based on predefined variables including overtime thresholds and preference override options.

18. The method of claim 16, further comprises steps of, evaluating, at the computing device via the analytic module, leave, time-off records and availability data of the employee to ensure no shifts are assigned on zero-preference or unavailable days;
verifying, at the computing device via the analytic module, employee qualification to confirm eligibility for assigned shifts based on required certification or license type;
ensuring, at the computing device via the analytic module, each employee is assigned to only one shift per day in compliance with labor and fatigue standards;
ensuring, at the computing device via the analytic module, each employee is assigned within predefined capacity parameters corresponding to the specific shift, location, and time;
detecting, at the computing device via the analytic module, manually assigned shifts and ensure manual assignments remain unaltered during automated optimization processes;
calculating, at the computing device via the analytic module, total assigned working hours to enforce maximum limits defined by contractual and regulatory maximum working hour limits, and
verifying, at the computing device via the analytic module, overtime consent enforcement to avoid assigning shifts beyond standard working hours for employee who have not agreed to work overtime.

19. The method of claim 16, further comprises steps of, ensuring, at the computing device via the analytic module, combined overtime hours across all the employee do not exceed the global company-defined limit;
ensuring, at the computing device via the analytic module, the employees do not exceed the allowed number of consecutive working days and hours to prevent burnout and maintain compliance;
performing, at the computing device via the analytic module, two-week continuity analysis to detect excessive continuous work cycles;
validating, at the computing device via the analytic module, that each shift assignment complies with predefined shift, location, and time parameters, and detecting any assignments that do not conform to the predefined parameters;
analyzing, at the computing device via the analytic module, and balancing overall workload distribution to ensure fair allocation of total hours and shifts among all available employees, and
enabling, at the computing device via the analytic module, automated computation of bonuses and penalty deductions based on predefined performance thresholds via a payroll system.

20. The method of claim 16, further comprises steps of,
notifying, at the computing device via a notification module, the employee regarding changes made to finalized schedules and tasks, and
generating, at the computing device via a notification module, one or more alerts to the scheduler regarding employee last-minute updates and compliance breaches, and maintaining a complete history of all manual overrides performed on schedules.
